(19) United States
(12) Patent Application Publication
(10) Pub. No.: US 2021/0281084 A1
(43) Pub. Date: Sep. 9, 2021

(54) BATTERY MODULE-LEVEL BALANCING OF PORTABLE POWER SUPPLY

(71) Applicant: MILWAUKEE ELECTRIC TOOL CORPORATION, Brookfield, WI (US)

(72) Inventors: Chun Jian Tang, West Allis, WI (US); Benjamin C. Tesch, Milwaukee, WI (US); Chien-Chih Chao, Menomonee Falls, WI (US); Brian M. Hockers, Nashotah, WI (US)

(21) Appl. No.: 17/190,158

(22) Filed: Mar. 2, 2021

Related U.S. Application Data
(60) Provisional application No. 62/985,403, filed on Mar. 5, 2020.

(51) Int. Cl. H02J 7/00

(52) U.S. Cl. CPC H02J 7/0014; H02J 7/007182

(57) ABSTRACT

A portable power supply including a first subcore including a first plurality of battery cells, a second subcore including a second plurality battery cells and electrically connected in series with the first subcore, and a controller including an electronic processor. The controller is configured to receive a first voltage value indicative of a voltage of the first plurality of battery cells from the first subcore and a second voltage value indicative of a voltage of the second plurality of battery cells from the second subcore. The controller is further configured to determine a difference between the first voltage value and the second voltage value, compare the difference to a balance threshold, and perform a balancing operation when the difference is greater than or equal to the balance threshold.

### RELATED APPLICATIONS

This application claims the benefit of U.S. Provisional Patent Application No. 62/985,403, filed Mar. 5, 2020, the entire content of which is hereby incorporated by reference.

### FIELD

Embodiments described herein relate to portable power supplies.

### SUMMARY

Portable power supply devices can include multiple subcore battery modules that each include a stack of two or more battery cells connected in series and/or parallel. During operation of a portable power supply device, current drawn from each of the multiple subcore modules may result in a different state of charge level for each of the multiple subcore battery modules. If the imbalance is not addressed, the imbalance in state of charge levels of the subcore battery modules can cause, for example, the runtime of the portable power supply device to decrease.

Portable power supplies described herein include a first subcore including a first plurality of battery cells, a second subcore including a second plurality battery cells and electrically connected in series with the first subcore, and a controller including an electronic processor. The controller is configured to receive a first voltage value indicative of a voltage of the first plurality of battery cells from the first subcore and a second voltage value indicative of a voltage of the second plurality of battery cells from the second subcore. The controller is further configured to determine a difference between the first voltage value and the second voltage value, compare the difference to a balance threshold, and perform a balancing operation when the difference is greater than or equal to the balance threshold.

In some aspects, the controller is further configured to determine whether the first voltage value is greater than the second voltage value.

In some aspects, the controller is further configured to operate the first subcore in an active mode of operation when the first voltage value is greater than the second voltage value, determine whether the first voltage value has decreased to a termination threshold, and operate the first subcore in a normal mode of operation when the first voltage value has reached the termination threshold.

In some aspects, the controller is further configured to activate a first magnetic field source included in the first subcore when the first voltage value is greater than the second voltage value to enable current flow from the first plurality of battery cells to a load through a first reed switch that is closed when the first magnetic field source is activated, determine whether the first voltage value has decreased to a termination threshold, and deactivate the first magnetic field source when the first voltage value has reached the termination threshold.

In some aspects, the controller is further configured to energize a first relay coil included in the first subcore when the first voltage value is greater than the second voltage value to enable current flow from the first plurality of battery cells to a load through a first relay that is closed when the first relay coil is energized, determine whether the first voltage value has decreased to a termination threshold and de-energize the first relay coil when the first voltage value has reached the termination threshold.

In some aspects, the controller is further configured to increase a temperature of a heating element included in the first subcore when the first voltage value is greater than the second voltage value to increase current flow from the first plurality of battery cells through a leakage device included in the first subcore, determine whether the first voltage value has decreased to a termination threshold, and decrease the temperature of the heating element when the first voltage value has reached the termination threshold.

In some aspects, the controller is further configured to control a battery front end device included in the first subcore when the first voltage value is greater than the second voltage value to enable current flow from the first plurality of battery cells to a load, determine whether the first voltage value has decreased to a termination threshold, and control the battery front end device included in the first subcore to disable current flow from the first plurality of battery cells when the first voltage value has reached the termination threshold.

In some aspects, the load is electrically connected to an output pin of the battery front end device.

Methods described herein provide for balancing subcore voltages in a portable power supply including a first subcore including a first plurality of battery cells, a second subcore including a second plurality of battery cells and electrically connected in series with the first subcore, and a controller including an electronic processor. The methods include receiving, using the controller, a first voltage value indicative of a voltage of the first plurality of battery cells from the first subcore and a second voltage value indicative of a voltage of the second plurality of battery cells from the second subcore. The methods further include determining, using the controller, a difference between the first voltage value and the second voltage value, comparing the difference to a balance threshold, and performing a balancing operation when the difference is greater than or equal to the balance threshold.

In some aspects, the method further includes determining, using the controller, whether the first voltage value is greater than the second voltage value.

In some aspects, the method further includes operating, using the controller, the first subcore in an active operation mode, determining, using the controller, whether the first voltage value has decreased to a termination threshold, and operating the first subcore in a normal operating mode when the first voltage value has reached the termination threshold.

In some aspects, the method further includes activating, using the controller, a first magnetic field source included in the first subcore, closing, using the first magnetic field source, a first reed switch included in the first subcore to enable current to flow from the plurality of battery cells to a first load included in the first subcore, determining, using the controller, whether the first voltage value has decreased to a termination threshold, and deactivating, using the controller, the first magnetic field source when the first voltage value has reached the termination threshold.

In some aspects, the method further includes energizing, using the controller, a first relay coil included in the first subcore, closing, using the first relay coil, a first relay included in the first subcore to enable current to flow from the plurality of battery cells to a first load included in the first subcore, determining, using the controller, whether the first voltage value has decreased to a termination threshold, and de-energizing, using the controller, the first relay coil when the first voltage value has reached the termination threshold.

In some aspects, the method further includes increasing, using the controller, temperature of a heating element included in the first subcore, increasing, using the heating element, temperature of a leakage device included in the first subcore to enable current flow from the first plurality of battery cells through the leakage device, determining, using the controller, whether the first voltage value has decreased to a termination threshold, and decreasing, using the controller, temperature of the heating element when the first voltage value has reached the termination threshold.

In some aspects, the method further includes enabling, using a battery front end device included in the first subcore, current flow from the first plurality of battery cells to a load, determining, using the controller, whether the first voltage value has decreased to a termination threshold, and disabling, using the battery front end device, current flow from the first plurality of battery cells when the first voltage value has reached the termination threshold.

In some aspects, the load is electrically connected to an output pin of the battery front end device.

Methods described herein provide for charging one or more subcores in a portable power supply. The portable power supply includes a first subcore including a first plurality of battery cells, a second subcore including a second plurality of battery cells and electrically connected in series with the first subcore, and a controller including an electronic processor. The methods include charging the first plurality of battery cells and the second plurality of battery cells. The methods further include receiving, using the controller, a first voltage value indicative of a voltage of the first plurality of battery cells from the first subcore and a second voltage value indicative of a voltage of the second plurality of battery cells from the second subcore. The methods also include determining, using the controller, a difference between the first voltage value and the second voltage value, comparing the difference to a balance threshold, and performing a balancing operation when the difference is greater than or equal to the balance threshold.

In some aspects, the method further includes comparing, using the controller, the first voltage value to a charge threshold, determining, using the controller, whether the first voltage value is greater than or equal to the charge threshold, and terminating charging of the first plurality of battery cells when the first voltage value is greater than or equal to the charge threshold.

In some aspects, the method further includes comparing, using the controller, the second voltage value to a charge threshold, determining, using the controller, whether the second voltage value is greater than or equal to the charge threshold, and terminating charging of the second plurality of battery cells when the first voltage value is greater than or equal to the charge threshold.

In some aspects, performing the balancing operation includes determining, using the controller, whether the first voltage value is greater than the second voltage value, charging the second plurality of battery cells for an amount of time when the first voltage value is greater than the second voltage value, delaying charging of the first plurality of battery cells for the amount of time when the first voltage value is greater than the second voltage value, and charging the first plurality of battery cells and the second plurality of battery cells after the amount of time has elapsed.

Portable power supplies described herein include a first subcore including a first plurality of battery cells, a second subcore including a second plurality battery cells and electrically connected in series with the first subcore, and a controller including an electronic processor. The controller is configured to charge the first plurality of battery cells and the second plurality of battery cells, receive a first voltage value indicative of a voltage of the first plurality of battery cells from the first subcore, receive a second voltage value indicative of a voltage of the second plurality of battery cells from the second subcore, determine a difference between the first voltage value and the second voltage value, compare the difference to a balance threshold, and perform a balancing operation when the difference is greater than or equal to the balance threshold.

In some aspects, the controller is further configured to compare the first voltage value to a charge threshold, determine whether the first voltage value is greater than or equal to the charge threshold, and terminate charging of the first plurality of battery cells when the first voltage value is greater than or equal to the charge threshold.

In some aspects, the controller is further configured to compare the second voltage value to a charge threshold, determine whether the second voltage value is greater than or equal to the charge threshold, and terminate charging of the second plurality of battery cells when the first voltage value is greater than or equal to the charge threshold.

In some aspects, the controller is further configured to determine whether the first voltage value is greater than the second voltage value, charge the second plurality of battery cells for an amount of time when the first voltage value is greater than the second voltage value, delay charging of the first plurality of battery cells for the amount of time when the first voltage value is greater than the second voltage value, and charge the first plurality of battery cells and the second plurality of battery cells after the amount of time has elapsed.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Other aspects of the invention will become apparent by consideration of the detailed description and accompanying drawings.

### BRIEF DESCRIPTION OF THE DRAWINGS

FIG. 1 illustrates a perspective view of a portable power supply device.

FIG. 2 illustrates a schematic diagram of the portable power supply device of FIG. 1.

FIG. 3 illustrates another schematic diagram of the portable power supply device of FIG. 1.

FIG. 4 illustrates a control system for the portable power supply device of FIG. 1.

FIG. 5 illustrates a schematic diagram of the portable power supply device of FIG. 1.

FIG. 6 is a process for balancing battery subcores in the portable power supply device of FIG. 1.

FIG. 7 illustrates a schematic diagram of battery subcores included the portable power supply device of FIG. 1.

FIG. 8 is a process for balancing the battery subcores of FIG. 7.

FIG. 9 illustrates a schematic diagram of battery subcores included in the portable power supply device of FIG. 1.

FIG. 10 is a process for balancing the battery subcores of FIG. 9.

FIG. 11 illustrates a schematic diagram of battery subcores included in the portable power supply device of FIG. 1.

FIG. 12 is a process for balancing the battery subcores of FIG. 11.

FIG. 13 illustrates a schematic diagram of battery subcores included in the portable power supply device of FIG. 1.

FIG. 14 is a process for balancing the battery subcores of FIG. 13.

FIG. 15 illustrates a schematic diagram of battery subcores included in portable power supply device of FIG. 1.

FIG. 16 is a process for balancing the battery subcores of FIG. 15.

FIG. 17 illustrates a schematic diagram of battery subcores included in the portable power supply device of FIG. 1.

FIG. 18 is a process for charging the battery subcores of FIG. 17.

### DETAILED DESCRIPTION

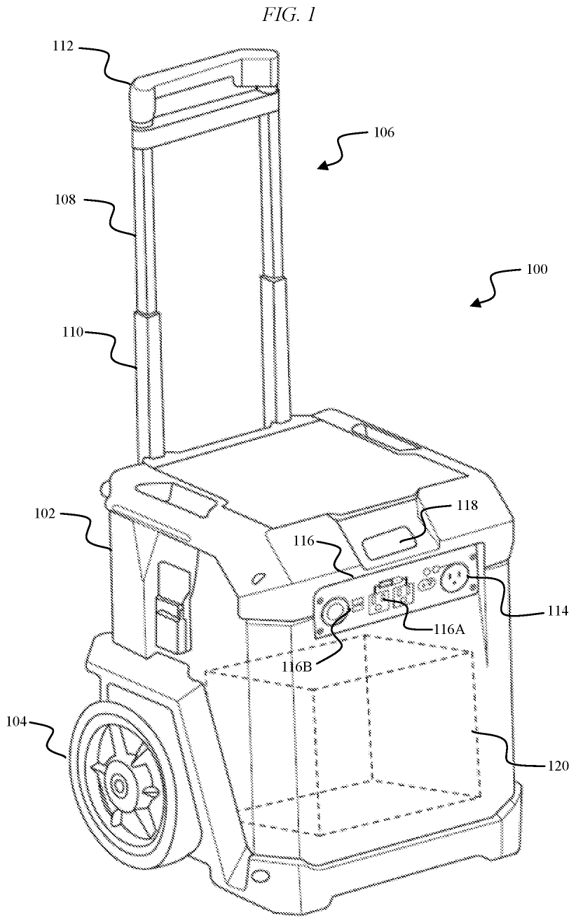

FIG. 1 illustrates a portable power supply device or power supply 100. The portable power supply device 100 includes, among other things, a housing 102. In some embodiments, the housing 102 includes one or more wheels 104 and a handle assembly 106. In the illustrated embodiment, the handle assembly 106 is a telescoping handle movable between an extended position and a collapsed position. The handle assembly 106 includes an inner tube 108 and an outer tube 110. The inner tube 108 fits inside the outer tube 110 and is slidable relative to the outer tube 110. The inner tube 108 is coupled to a horizontal holding member 112. In some embodiments, the handle assembly 106 further includes a locking mechanism to prevent inner tube 108 from moving relative to the outer tube 110 by accident. The locking mechanism may include notches, sliding catch pins, or another suitable locking mechanism to inhibit the inner tube 108 from sliding relative to the outer tube 110 when the handle assembly 106 is in the extended position and/or in the collapsed position. In practice, a user holds the holding member 112 and pulls upward to extend the handle assembly 106. The inner tube 108 slides relative to the outer tube 110 until the handle assembly 106 locks in the extended position. The user may then pull and direct the power supply 100 by the handle assembly 106 to a desired location. The wheels 104 of the power supply 100 facilitate such movement.

The housing 102 of power supply 100 further includes a power input panel 114, a power output panel 116, and a display 118. In the illustrated embodiment, the power input panel 114 includes multiple electrical connection interfaces configured to receive power from an external power source. In some embodiments, the external power source may be a DC power source, for example, a photovoltaic cell (e.g., a solar panel), or the power source may be an AC power source, for example, a conventional wall outlet. In some embodiments, the power input panel 114 is replaced by or additionally includes a cable configured to plug into a conventional wall outlet. The power received by power input panel 114 may be used to charge an internal power source 120 disposed within the housing 102 of power supply 100.

The power output panel 116 includes one more power outlets. In the illustrated embodiment, the power output panel 116 includes a plurality of AC power outlets 116A and DC power outlets 116B. It should be understood that number of power outlets included in power output panel 116 is not limited to the power outlets illustrated in FIG. 1. For example, in some embodiments of the power supply 100, the power output panel 116 may include more or fewer power outlets than the power outlets included in the illustrated embodiment of power supply 100. The power output panel 116 is configured to provide power from the internal power source 120 to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output panel 116.

The display 118 is configured to indicate a state of the power supply 100 to a user, such as state of charge of the internal power source 120 and/or fault conditions. In some embodiments the display 118 includes one or more light-emitting diode (“LED”) indicators configured to illuminate and display a current state of charge of internal power source 120. In some embodiments, the display 118 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In other embodiments, the power supply 100 does not include a display.

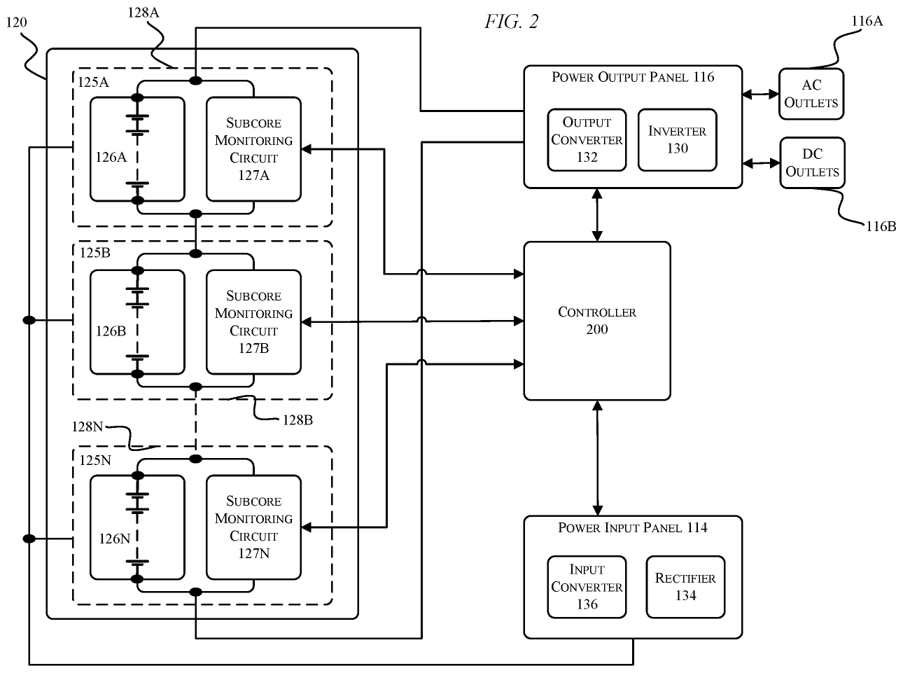

FIG. 2 is a generalized schematic illustration of the power supply 100. As shown in FIG. 2, the internal power source 120 includes a plurality of subcore modules 125A-125N. At least two subcore modules, 125A and 125B, are included in the internal power source 120. However, the internal power source 120 may include any desired number, N, of subcore modules 125A-125N. Although illustrated as being connected in series, the subcore modules 125A-125N may be electrically connected in series, in parallel, and/or a combination thereof.

The following description of an individual subcore module 125 is written with respect to subcore module 125A. However, it should be understood that each individual subcore module 125 included in the internal power source 120 includes similar components. Subcore module 125A includes a stack, or plurality, of battery cells 126A. The stack of battery cells 126A includes at least two battery cells electrically connected in series. However, the stack of battery cells 126A may include as many battery cells as desired. For example, the stack of battery cells 126A may include two, three, four, or more battery cells electrically connected in series. In some embodiments, the stack of battery cells 126A includes battery cells that are electrically connected in parallel. In some embodiments, the stack of battery cells 126A includes battery cells that are electrically connected in series and in parallel.

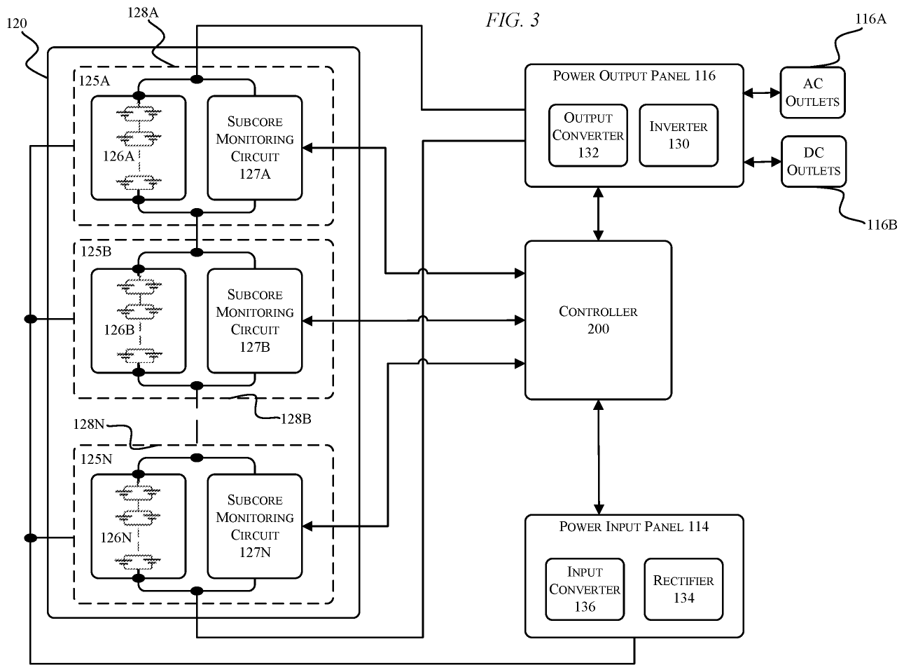

The battery cells included in the stack of battery cells 126A are rechargeable battery cells having a lithium ion chemistry, such as lithium phosphate or lithium manganese. In some embodiments, the battery cells included in the stack of battery cells 126A may have lead acid, nickel cadmium, nickel metal hydride, and/or other chemistries. Each battery cell in the stack of battery cells 126A has an individual voltage capacity. The voltage capacity of an individual battery cell included in the stack of battery cells 126A may be, for example, 4.2V, 3.6V, 2.4V, or some other voltage value. For exemplary purposes, it will be assumed that the voltage capacity of an individual battery cell included in the stack of battery cells 126A is equal to 4.2V. Accordingly, if the stack of battery cells 126A includes two battery cells connected in series, the voltage capacity of the stack of battery cells 126A (or the subcore module 125A) will be equal to 8.4V. Similarly, if the stack of battery cells 126A includes five battery cells connected in series, the voltage capacity of the stack of battery cells 126A will be equal to 21V. As shown in FIG. 3, the amp hour capacity of subcore module 125A may be increased by adding battery cells connected in parallel to the stack of battery cells 126A.

Subcore module 125A further includes a subcore monitoring circuit 127A that is electrically connected to the stack of battery cells 126A and a controller 200 of the power supply 100. The subcore monitoring circuit 127A receives power from the stack of battery cells 126A during operation of the power supply 100. The subcore monitoring circuit 127A is configured to sense the state-of-charge (“SOC”) level, or voltage value, of the stack of battery cells 126A and transmit the voltage readings to the controller 200. The voltage level of subcore module 125A may be determined by measuring the total open circuit voltage of the stack of battery cells 126A or by summing the open circuit voltage measurement of each parallel string of battery cells in the stack of battery cells 126A. In some embodiments, the subcore monitoring circuit 127A is additionally configured to sense a discharge current of the stack of battery cells 126A (e.g., using a current sensor) and/or a temperature of the subcore module 125A (e.g., using a temperature sensor) and transmit the sensed current and/or temperature readings to the controller 200. The subcore monitoring circuit 127A is further configured to receive commands from the controller 200 during operation of the power supply 100.

In some embodiments, the subcore monitoring circuit 127A is electrically connected to subcore monitoring circuits 127A-127N included in other subcore modules 125A-125N, such as subcore monitoring circuit 127B included in subcore module 125B. In the illustrated embodiment, each subcore monitoring circuit 127A-N is electrically connected to the controller 200. In other embodiments, only one subcore monitoring circuit 127 is electrically connected to the controller 200. In such embodiments, the subcore monitoring circuits 127A-127N are electrically connected to one another in a daisy chain fashion. For example, if only subcore monitoring circuit 127A is electrically connected to the controller 200, the subcore monitoring circuit 127A is configured to forward voltage readings sensed by the subcore monitoring circuit 127B to the controller 200. Likewise, the subcore monitoring circuit 127A is configured to forward commands from the controller 200 to the subcore monitoring circuit 127B. In other embodiments, the subcore modules 125A-125N may not include individual subcore monitoring circuits 127A-127N. Rather, the controller 200 may be configured to directly perform functions implemented by the subcore monitoring circuits 127A-127N described above.

In some embodiments, the stack of battery cells 126A and subcore monitoring circuit 127A are disposed within a subcore housing 128A of the subcore module 125A. In some embodiments, only the stack of battery cells 126A is disposed within the subcore housing 128A. In some embodiments, the subcore module 125A does not include a subcore housing 128A.

As described above, the internal power source 120 of power supply 100 includes at least two subcore modules, 125A and 125B, electrically connected in series and/or parallel. For example, if the internal power source 120 includes a first subcore module 125A and a second subcore module 125B electrically connected in series, where each of the first subcore module 125A and the second subcore module 125B has a subcore voltage of 21V, the combined voltage of the first subcore module 125A and second subcore module 125B equals 42V. Accordingly, the combined voltage of the internal power source is 42V. Likewise, if the internal power source includes five subcore modules 125A-125E connected in series, where each of the subcore modules 125A-125E has a voltage of 21V, the combined voltage of the internal power source is 105V. Any number of subcore modules 125A-125N may be electrically connected in series and/or parallel to achieve a desired combined output voltage or power for internal power source 120.

The combined voltage of subcore modules 125A-125N included in the internal power source 120 is provided to power output panel 116 for powering the one or more peripheral devices. The power output panel 116 includes an inverter circuit 130 configured to convert DC voltage supplied by the internal power source 120 to AC voltage for charging and/or powering peripheral device connected to AC outlets 116A. The power output panel 116 also includes an output converter circuit 132 that is configured to buck and/or boost the DC voltage provided by the internal power source 120 to the one or more peripheral devices electrically connected to power output panel 116.

As shown in FIG. 2, the subcore modules 125A-125N included in the internal power source 120 are electrically connected to the power input panel 114. The power input panel 114 includes a rectifier circuit 134 and an input converter circuit 136. The rectifier circuit 134 is configured to convert AC power received from an external power source to DC power for charging the stacks of battery cells 126A-126N included in subcore modules 125A-125N. The input converter circuit 136 is configured to buck and/or boost the voltage received by input power panel 114 to a desired charging voltage level for charging the stacks of battery cells 126A-126N included in subcore modules 125A-125N.

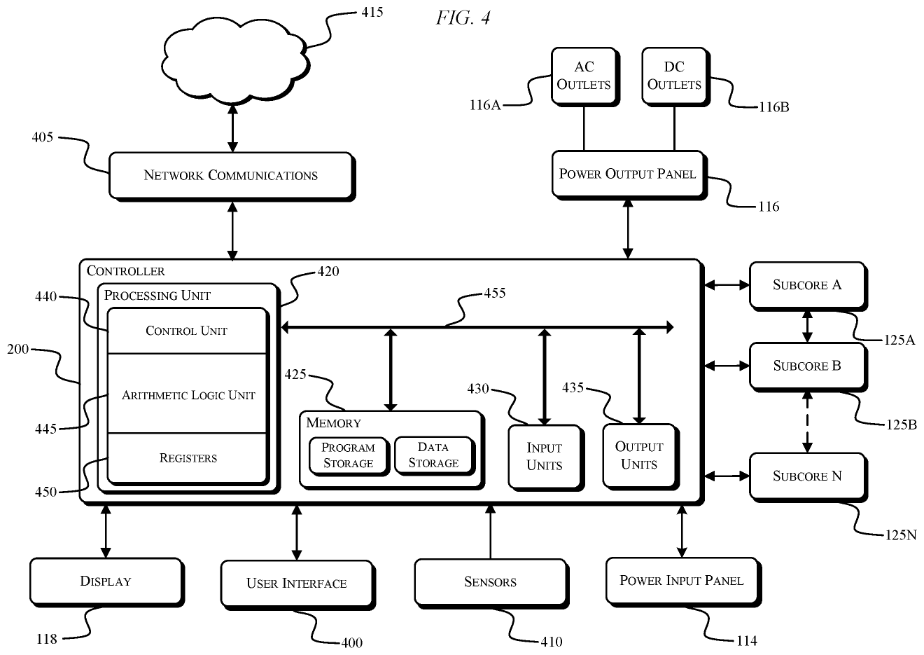

FIG. 4 is a generalized schematic illustration of the controller 200 of power supply 100. The controller 200 is electrically and/or communicatively connected to a variety of modules or components of the power supply 100. For example, the illustrated controller 200 is connected to the power input panel 114, the power output panel 116, the display 118, and subcore modules 125A-125N included in internal power source 120. Persons skilled in the art will recognize that electrical and/or communicative connection between the controller 200 and subcore module 125A (as well as subcore modules 125B-125N) includes electrical and/or communicative connection between the controller 200 and components of subcore module 125A, such as, but not limited to, the stack of battery cells 126A and/or subcore monitoring circuit 127A.

The controller 200 is additionally electrically and/or communicatively connected to a user interface 400, a network communications module 405, and a plurality of sensors 410. The network communications module 405 is connected to a network 415 to enable the controller 200 to communicate with peripheral devices in the network, such as a smartphone or a server. The sensors 410 include, for example, one or more voltage sensors, one or more current sensors, one or more temperature sensors, etc. Each of the sensors 410 generates one or more output signals that are provided to the controller 200 for processing and evaluation. The user interface 400 is included to provide user control of the power supply 100. The user interface 400 can include any combination of digital and analog input devices required to achieve a desired level of control for the power supply 100. For example, the user interface 400 may include a plurality of knobs, a plurality of dials, a plurality of switches, a plurality of buttons, or the like. In some embodiments, the user interface 400 is integrated with the display 118 (e.g., as a touchscreen display).

The controller 200 includes combinations of hardware and software that are operable to, among other things, control the operation of the power supply 100, communicate over the network 415, receive input from a user via the user interface 400, provide information to a user via the display 118, etc. For example, the controller 200 includes, among other things, a processing unit 420 (e.g., a microprocessor, a microcontroller, an electronic processor, an electronic controller, or another suitable programmable device), a memory 425, input units 430, and output units 435. The processing unit 420 includes, among other things, a control unit 440, an arithmetic logic unit (“ALU”) 445, and a plurality of registers 450 (shown as a group of registers in FIG. 4), and is implemented using a known computer architecture (e.g., a modified Harvard architecture, a von Neumann architecture, etc.). The processing unit 420, the memory 425, the input units 430, and the output units 435, as well as the various modules or circuits connected to the controller 200 are connected by one or more control and/or data buses (e.g., common bus 455). The control and/or data buses are shown generally in FIG. 4 for illustrative purposes. Although the controller 200 is illustrated in FIG. 4 as one controller, the controller 200 could also include multiple controllers configured to work together to achieve a desired level of control for the power supply 100. As such, any control functions and processes described herein with respect to the controller 200 could also be performed by two or more controllers functioning in a distributed manner.

The memory 425 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 420 is connected to the memory 425 and is configured to execute software instructions that are capable of being stored in a RAM of the memory 425 (e.g., during execution), a ROM of the memory 425 (e.g., on a generally permanent basis), or another non-transitory computer readable medium such as another memory or a disc. Software included in the implementation of the power supply 100 and controller 200 can be stored in the memory 425 of the controller 200. The software includes, for example, firmware, one or more applications, program data, filters, rules, one or more program modules, and other executable instructions. The controller 200 is configured to retrieve from the memory 425 and execute, among other things, instructions related to the control processes and methods described herein. In other embodiments, the controller 200 includes additional, fewer, or different components.

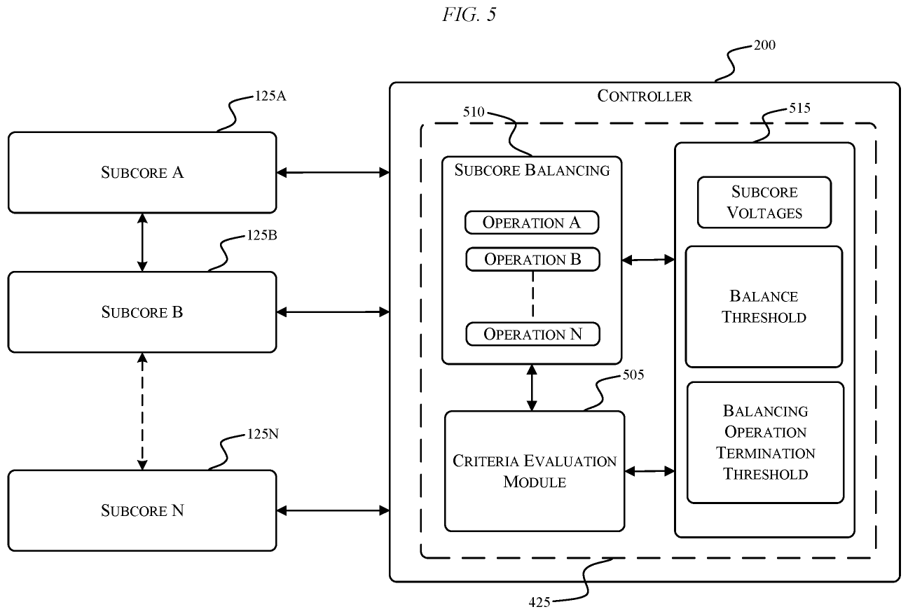

During operation of the power supply 100, the controller 200 is configured to monitor voltage signals received from the subcore modules 125A-125N to determine whether a subcore unbalanced condition is present in the internal power source 120. As described above with respect to FIG. 2, the subcore monitoring circuits 127A-N sense the voltage levels or SOC of the stacks of battery cells 126A-126N included in subcore modules 125A-125N and transmit the sensed voltage values to the controller 200. With reference to FIG. 5, the sensed voltage values of subcore modules 125A-125N are, for example, stored in the plurality of registers 450 included in processing unit 420 of controller 200. In some embodiments, the voltage values of subcore modules 125A-125N are stored in the RAM of memory 425. The voltage values of subcore modules 125A-125N may be updated in a continuous, or periodic, manner. For example, subcore monitoring circuit 127A is configured to sense and transmit an updated voltage value of the stack of battery cells 126A included in subcore module 125A at a selectable or configurable sampling rate, such as 1 Hz.

In some embodiments, the controller 200 is configured to execute, using the processing unit 420, a criteria evaluation module 505 and a corresponding subcore evaluation program stored in the memory 425. A subcore balancing module 510 stores one or more balancing operations (e.g., balancing operations A, B, N, etc.). The balancing operations correspond to balancing operations for particular subcore modules 125A-125N, or different balancing operations that are applicable to each subcore module 125A-125N. Particular voltage values for the subcore modules 125A-125N and balancing threshold values are stored in a voltage storage module 515. While executing the subcore evaluation program, the controller 200 is configured to determine or calculate differences between the voltage values of subcore modules 125A-125N. For example, if the internal power source 120 of power supply 100 includes two subcore modules, subcore module 125A and subcore module 125B, the controller 200 calculates a difference between the voltage values of subcore module 125A and subcore module 125B. If, for example, the voltage value of subcore module 125A is equal to 21V and the voltage value of subcore module 125B is equal to 20V, the calculated voltage difference between subcore module 125A and subcore module 125B is equal to 1V. As a result, the voltage values of subcore module 125A and subcore module 125B differ by approximately 4.8%. Although the example provided refers to the internal power source 120 as having two subcore modules 125A and 125B, it should be understood that the controller 200 executes the subcore evaluation program for an internal power supply 120 having any number of subcore modules 125A-125N. Accordingly, the controller 200 is configured to determine or calculate a difference between the voltage values of each respective subcore module 125A-125N. In some embodiments, the calculated voltage differences between subcore modules 125A-125N are stored in the plurality of registers 450. In other embodiments, the calculated voltage value differences may be stored in the RAM of memory 425.

The calculated voltage differences are compared to a balance threshold. The balance threshold is a configurable value that may be stored memory 425 of controller 200. In some embodiments, the balance threshold is a scalar voltage value, such as 0.5 volts. In other embodiments, the balance threshold is a configurable percentage value. For example, the balance threshold is a percentage difference between voltage values, such as 1%. If the controller 200 determines at least one difference between any of the voltages of subcore modules 125A-125N is greater than or equal to the balance threshold, the controller 200 performs a balancing operation. Various embodiments of the balancing operation will be described in detail below.

With reference to the example provided above, the controller 200 determines the difference between the voltage values of subcore module 125A and subcore module 125B to be 1V. If the balance threshold is equal to 0.5V, the controller 200 determines that the voltage difference (1 V) between subcore module 125A and subcore module 125B exceeds the balance threshold. Accordingly, the controller 200 performs a balancing operation to reduce the difference, or unbalance, between the voltage values of subcore module 125A and subcore module 125B. In some embodiments, the controller 200 is configured to perform the balancing operation for a selectable or configurable amount of time, such as 15 seconds. In some embodiments, the controller 200 performs the balancing operation until the unbalanced condition between subcore modules 125A and 125B is no longer present. In such embodiments, the controller 200 performs the balancing operation until the voltage difference between subcore module 125A and subcore module 125B is below the balance threshold. In some embodiments, the controller 200 performs the balancing operation until the voltage difference between subcore module 125A and subcore module 125B is below a balancing operation termination threshold, wherein the balancing operation termination threshold is a configurable threshold that is less than the balance threshold. For example, assuming the balance threshold is 0.5V, the balancing operation termination threshold may be set to 0.1V.

Although the example provided above refers to the internal power source 120 as having two subcore modules 125A and 125B, it should be understood that the controller 200 executes the subcore evaluation program for an internal power supply 120 having any number of subcore modules 125A-125N. Accordingly, the controller 200 is configured to determine or calculate a difference between the voltage values of each respective subcore module 125A-125N. If the controller 200 determines that one or more voltage differences between subcore modules 125A-125N are greater than or equal to the balance threshold, the controller 200 is configured to perform the balancing operation.

In some embodiments, during execution of the subcore evaluation program, the controller 200 is configured to determine which of the subcore modules 125A-125N has a minimum voltage and which of the subcore modules 125A-125N has a maximum voltage. In such embodiments, the controller 200 calculates a difference between the maximum subcore voltage value and the minimum subcore voltage value and compares the difference to the balance threshold. If controller 200 determines the difference between the maximum subcore voltage value and the minimum subcore voltage value to be greater than or equal to the balance threshold, the controller 200 performs a balancing operation. The controller 200 performs the balancing operation for every subcore module 125A-125N having a voltage that is greater than the minimum subcore voltage value. In some embodiments, the controller 200 only performs the balancing operation on subcore modules 125A-125N having a voltage value that is greater than or equal to the minimum subcore voltage value by the balance threshold amount.

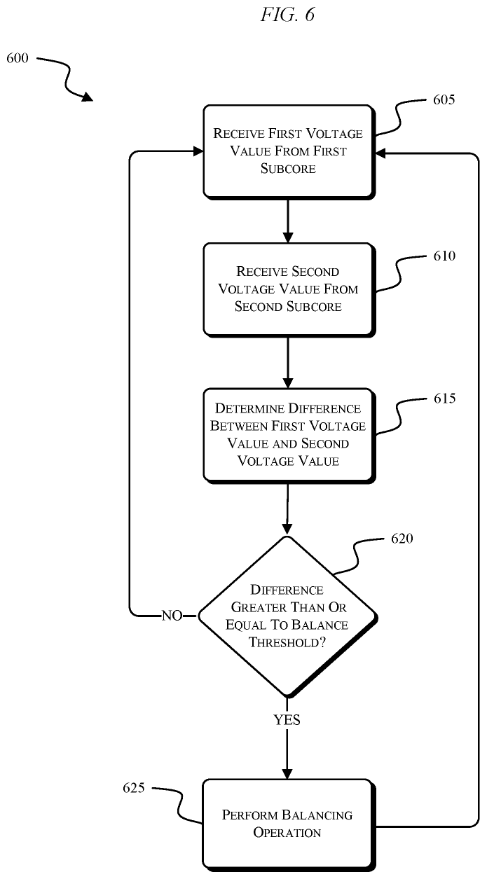

FIG. 6 is a flowchart illustrating a process 600 for balancing the voltage levels of subcore modules 125A-125N during operation of the power supply 100. It should be understood that the order of steps disclosed in process 600 can vary from the order illustrated in FIG. 6. The process 600 begins with the controller 200 configured to receive a first voltage value from a first subcore module 125A (STEP 605). As described above with respect to FIG. 2, the first subcore monitoring circuit 127A is configured to sense a first voltage value, or SOC level, of the first stack of battery cells 126A in the first subcore module 125A and transmit the first voltage value to the controller 200. The controller 200 is configured to receive a second voltage value from a second subcore module 125B (STEP 610). The controller 200 is then configured to determine a difference between the first voltage value and the second voltage value (STEP 615). For example, the difference between the first voltage value and the second voltage value is determined as a scalar value or as a percentage difference. If, at STEP 620, the controller 200 determines the difference between the first voltage value and the second voltage value to be less than a balance threshold, the process 600 returns to STEP 605 where the controller 200 is configured to receive an updated first voltage value of the first subcore module 125A. If, at STEP 620, the difference between the first voltage value and the second voltage value to greater than or equal to the balance threshold, the controller 200 performs a balancing operation (STEP 625). After the balancing operation is performed at STEP 625, the process 600 returns to STEP 605 where the controller 200 is configured to receive an updated first voltage value of the first subcore module 125A.

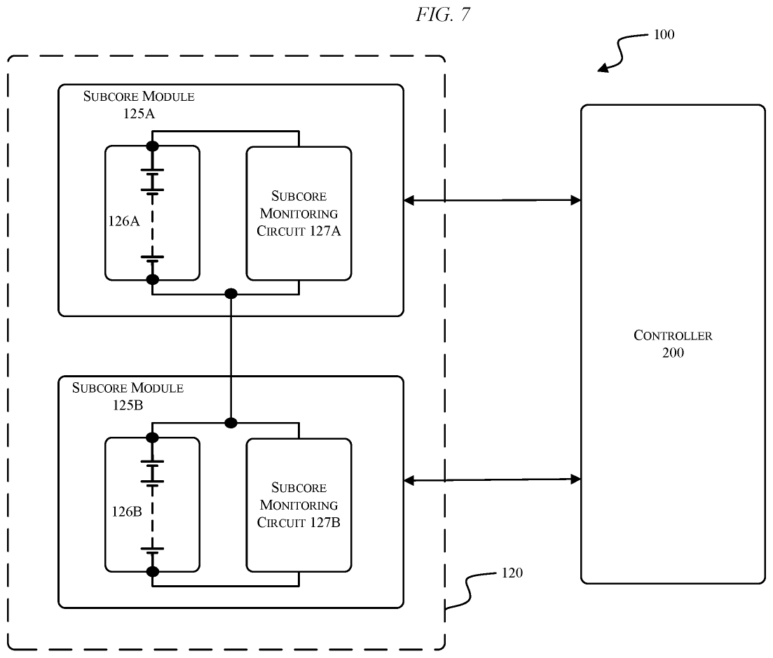

FIG. 7 illustrates an embodiment of the power supply 100 in which the controller 200 and subcore modules 125A-125N are configured to perform a balancing operation when the controller 200 determines that an unbalanced condition is present at STEP 620 of process 600. As shown in FIG. 7, subcore module 125A includes, among other things, a stack of battery cells 126A and a subcore monitoring circuit 127A. Likewise, subcore module 125B includes, among other things, a stack of battery cells 126B and a subcore monitoring circuit 127B. Although FIG. 7 only shows the internal power source 120 of power supply 100 as including subcore modules 125A and 125B, it should be understood that the internal power source 120 may include as many subcore modules 125A-125N as desired. Additionally, the balancing operation performed by controller 200 is used for an internal power source 120 having any number of subcore modules 125A-125N.

During execution of the balancing operation, the controller 200 is configured to command any unbalanced subcore modules 125A-125N having a high voltage value to enter an active mode of operation. The controller 200 is further configured to command any subcore modules 125A-125N not of a high voltage to enter and/or remain in a normal mode of operation. One or more subcore modules 125A-125N are determined to have a high voltage if the one or more subcore modules 125A-125N have voltages that are greater than a voltage level of one or more subcore modules 125A-125N by an amount that is greater than or equal to the balance threshold. For example, if the internal power source 120 includes subcore modules 125A and 125B, subcore module 125A may be determined to have a high voltage if the voltage value of subcore module 125A is greater than the voltage value of subcore module 125B by an amount that is greater than or equal to the balance threshold. Likewise, if the internal power source 120 includes subcore modules 125A-125N, subcore modules 125B-125N are determined to have high voltages if the voltage values of subcore modules 125B-125N are greater than the voltage value of subcore module 125A by an amount that is greater than or equal to the balance threshold. It should be understood that the above examples are not limiting, as the controller 200 may determine that a plurality of subcore modules 125A-125N to be of a high voltage or a low voltage.

As an illustrative example, the subcore module 125A is of a high voltage and was commanded by the controller 200 to operate in an active mode of operation. Additionally, the subcore module 125B is not of a high voltage and was commanded by the controller 200 to operate in a normal mode of operation. When operating in the active mode of operation, the subcore monitoring circuit 127A is configured to perform actions that draw high or higher than normal amounts of current from the stack of battery cells 126A. For example, the subcore monitoring circuit 127A may perform additional current draining actions such as, but not limited to, open wire checks, continuous scans and voltage sensing, built-in self-tests, and the like. In contrast, when operating in a normal mode of operation, the sub core monitoring circuit 127B of subcore module 125B does not perform additional current draining actions. Accordingly, during execution of the balancing operation, the subcore monitoring circuit 127A will draw more current from the stack of battery cells 126A than the subcore monitoring circuit 127B will draw form the stack of battery cells 126B. Thus, the voltage, or state of charge, of subcore module 125A will be reduced at faster rate than the voltage of subcore module 125B.

In some embodiments, the controller 200 controls subcore module 125A to operate in an active mode of operation until the voltage of subcore module 125A decreases by a configurable threshold amount, for example 0.5 V. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to operate in an active mode of operation until the voltage of subcore module 125A decreases by 2 volts. Alternatively, if the voltage of subcore module 125A is greater than the voltage of subcore module 125B by 0.5 volts, the controller 200 may command the subcore module 125A to operate in an active mode of operation until the voltage of subcore module 125A decreases by 0.5 volts. When the voltage of subcore module 125A decreases by the configurable threshold amount, the controller 200 commands the subcore module 125A to operate in a normal mode of operation.

In some embodiments, the controller 200 commands subcore module 125A to operate in an active mode of operation until the voltage difference between subcore module 125A and subcore module 125B is below a selectable or configurable threshold amount. The configurable threshold amount may be scalar voltage value, such as 0.1 V. In some embodiments, the configurable threshold amount is a maximum allowable percentage voltage difference, such as 0.2%. When subcore module 125A is operating in the active mode of operation, the controller 200 periodically determines an updated voltage difference between the first subcore module 125A and the second subcore module 125B. When the controller 200 determines the updated voltage difference between subcore module 125A and subcore module 125B is less than the configurable threshold amount, the controller 200 commands the subcore module 125A to operate in a normal mode of operation.

In other embodiments, the controller 200 commands the subcore module 125A to operate in an active mode of operation for a configurable amount of time, for example 15 seconds. The configurable amount of time may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to operate in an active mode of operation for 2 minutes. Alternatively, if the voltage of subcore module 125A is greater than the voltage of subcore module 125B by 0.5 volts, the controller 200 may command the subcore module 125A to operate in an active mode of operation for 30 seconds. When the controller 200 determines that subcore module 125A has been operating in an active mode of operation for the configurable amount of time, the controller 200 commands the subcore module 125A to operate in a normal mode of operation.

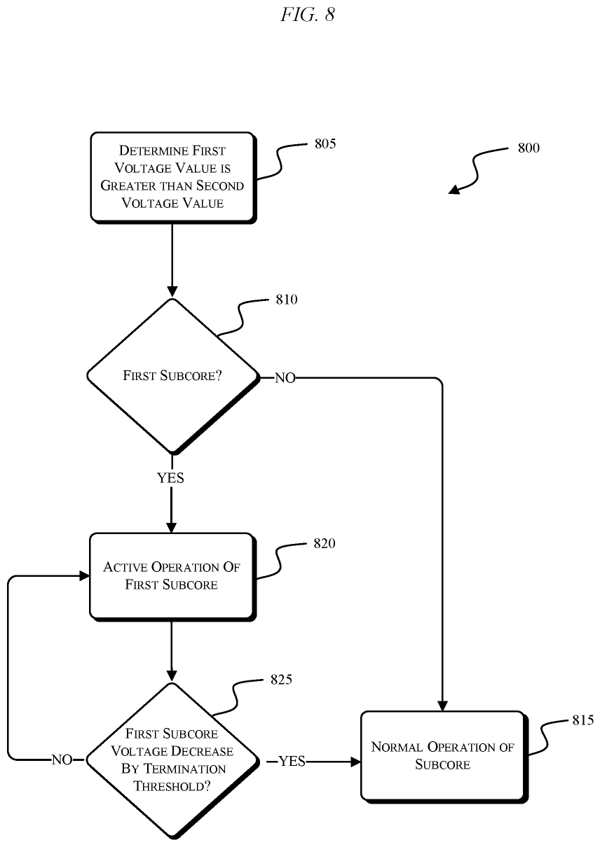

FIG. 8 is a flowchart illustrating a process 800 for a firmware-based balancing operation performed by controller 200 (e.g., at STEP 625 of process 600 described above). It should be understood that the order of steps disclosed in the process 800 could vary. The process 800 begins with the controller 200 determining that the first voltage value of subcore module 125A is greater than the second voltage value of subcore module 125B (STEP 805). At STEP 810, the controller 200 determines whether the subcore module being commanded is the first subcore module 125A. If, at STEP 810, the controller 200 determines that the second subcore module 125B is being commanded, the controller 200 commands the second subcore module 125B to operate in a normal mode of operation (STEP 815). If, at STEP 810, the controller 200 determines that the first subcore module 125A is being commanded, the controller 200 commands the first subcore module 125A to operate in an active mode of operation (STEP 820). At STEP 825, the controller 200 determines whether the first voltage value of the first subcore module 125A has decreased to a termination threshold. If, at STEP 825, the controller 200 determines that the first voltage value has not decreased to the termination threshold, the controller 200 commands the first subcore module 125A to continue operating in the active mode of operation (STEP 820). If, at STEP 825, the controller 200 determines that the first voltage value has decreased by the termination threshold, the controller 200 commands the first subcore module 125A to operate in the normal mode of operation (STEP 815). When the first subcore module 125A and the second subcore module 125B are operating in the normal operation mode, the process 800 is complete. With reference to FIG. 6, after the process 800 is performed at STEP 625 of process 600, the process 600 returns to STEP 605 where an updated first voltage value of the first subcore module 125A is received by the controller 200.

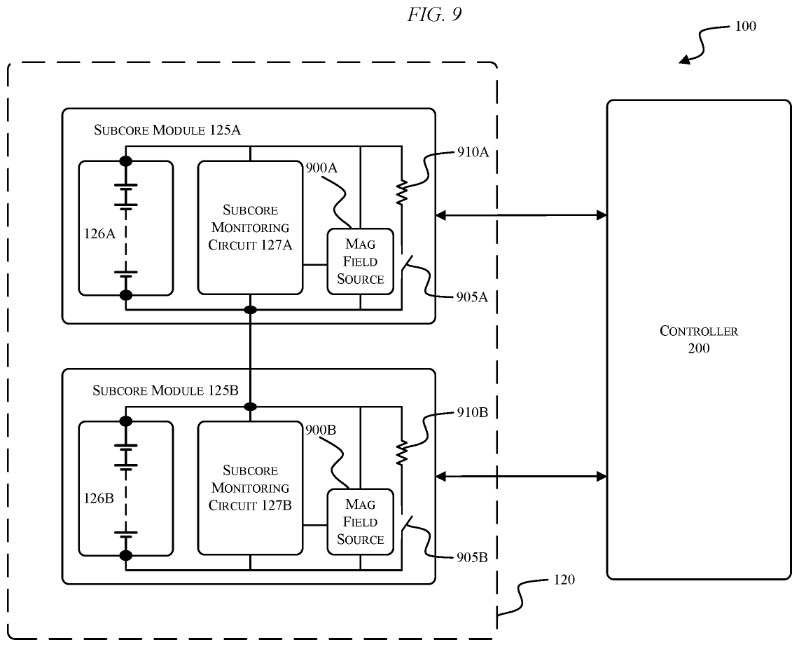

FIG. 9 illustrates an embodiment of the power supply 100 in which the controller 200 and subcore modules 125A-125N are configured to perform a balancing operation when the controller 200 determines that an unbalanced condition is present at STEP 620 of process 600. As shown in FIG. 9, subcore module 125A includes, among other things, a stack of battery cells 126A, a subcore monitoring circuit 127A, a magnetic field source 900A, a reed switch 905A, and load 910A. Likewise, subcore module 125B includes, among other things, a stack of battery cells 126B, a subcore monitoring circuit 127B, a magnetic field source 900B, a reed switch 905B, and load 910B. Magnetic field sources 900A and 900B are implemented as, for example, a permanent magnet or a coiled wire through which current passes. In some embodiments, reed switch 905A is replaced with a switch that is controlled by a hall-effect sensor. In some embodiments, the loads 910A and 910B are implemented as resistors, diodes, or another ohmic component. Although FIG. 9 only shows the internal power source 120 of power supply 100 as including subcore modules 125A and 125B, it should be understood that the internal power source 120 may include as many subcore modules 125A-125N as desired. Additionally, the balancing operation performed by controller 200 is used for an internal power source 120 having any number of subcore modules 125A-125N.

During execution of the balancing operation, the controller 200 is configured to command any unbalanced subcore modules 125A-125N having a high voltage value to activate the respective magnetic field sources 900A-900N. In some embodiments, the controller 200 commands the subcore monitoring circuits 127A-127N of the subcore modules 125A-125N having a high voltage to activate the respective magnetic field sources 900A-900N. When magnetic field source 900A-900N are activated, magnetic fields strong enough to open/close the reed switches 905A-905N are generated. Any subcore modules 125A-125N that are not of a high voltage are not commanded by the controller 200 to activate the respective magnetic field sources 900A-900N.

As an illustrative example, the subcore module 125A is of a high voltage and was commanded by the controller 200 to activate the magnetic field source 900A. Additionally, the subcore module 125B is not of a high voltage and was not commanded by the controller 200 to activate the magnetic field source 900B. When the magnetic field source 900A is activated, the normally-open reed switch 905A is closed, enabling current drawn from the stack of battery cells 126A to flow through the load 910A. In contrast, when the magnetic field source 900B of subcore module 125B is not activated, reed switch 905B remains open and current drawn from the stack of battery cells 126B does not flow through the load 910B. Accordingly, during execution of the balancing operation, subcore module 125A will consume more current from the stack of battery cells 126A when the magnetic field source 900A is active than subcore module 125B will consume from the stack of battery cells 126B when magnetic field source 900B is not active. Thus, the voltage, or state of charge, of subcore module 125A will be reduced at a faster rate than the voltage of subcore module 125B when the magnetic field source 900A is activated and magnetic field source 900B is not activated. In embodiments in which reed switches 905A and 905B are replaced with Hall Effect sensor controlled switches, the Hall Effect sensor controlled switches are closed in response to a Hall Effect sensor detecting generation of a magnetic field (e.g., based on a sensed amount of magnetic flux).

In some embodiments, the controller 200 commands subcore module 125A to activate magnetic field source 900A until the voltage of subcore module 125A decreases by a configurable threshold amount, for example 0.5 V. The magnetic field source 900A continues generating a magnetic field until the voltage of the stack of battery cells 126A decreases by the configurable threshold amount. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to activate the magnetic field source 900A until the voltage of subcore module 125A decreases by 2 volts. Alternatively, if the voltage of subcore module 125A is greater than the voltage of subcore module 125B by 0.5 volts, the controller 200 may command the subcore module 125A to activate the magnetic field source 900A until the voltage of subcore module 125A decreases by 0.5 volts. When the voltage of subcore module 125A decreases by the configurable threshold amount, the controller 200 commands subcore module 125A to deactivate the magnetic field source 900A. As a result, current drawn from the stack of battery cells 126A is no longer able to flow through load 910A.

In some embodiments, the controller 200 commands subcore module 125A to activate the magnetic field source 900A until the voltage difference between subcore module 125A and subcore module 125B is below a selectable or configurable threshold amount. The configurable threshold amount may be a scalar voltage value, such as 0.1 V. In some embodiments, the configurable threshold amount is a maximum allowable percentage voltage difference, such as 0.2%. When the magnetic field source 900A is activated, the controller 200 periodically determines an updated voltage difference between the first subcore module 125A and the second subcore module 125B. If the controller 200 determines the updated voltage difference between subcore module 125A and subcore module 125B is less than the configurable threshold amount, the controller 200 commands the subcore module 125A to deactivate the magnetic field source 900A. Accordingly, current drawn from the stack of battery cells 126A is no longer able to flow through load 910A.

In other embodiments, the controller 200 commands the subcore module 125A to activate the magnetic field source 900A for a configurable amount of time, for example 15 seconds. The configurable amount of time may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to activate the magnetic field source 900A for 2 minutes. Alternatively, if the voltage of subcore module 125A is greater than the voltage of subcore module 125B by 0.5 volts, the controller 200 may command the subcore module 125A to activate the magnetic field source 900A for 30 seconds. When the controller 200 determines that the magnetic field source 900A has been activated for the configurable amount of time, the controller 200 commands the subcore module 125A to deactivate the magnetic field source 900A. Accordingly, current drawn from the stack of battery cells 126A is no longer able to flow through load 910A.

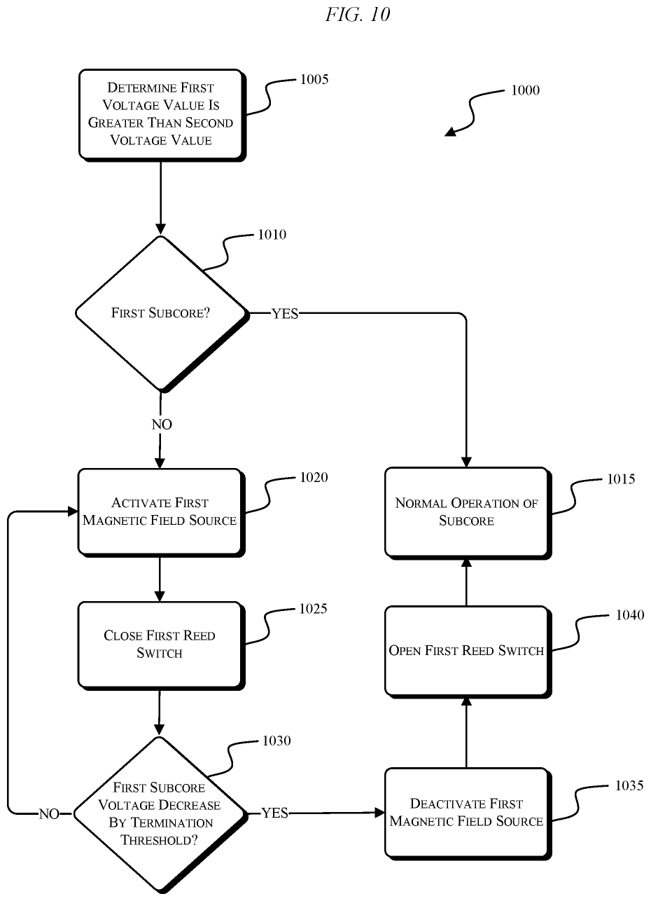

FIG. 10 is a flowchart illustrating a process 1000 for a magnetic activation balancing operation performed by controller 200 (e.g., at STEP 625 of process 600 described above). It should be understood that the order of steps disclosed in the magnetic activation balancing operation 1000 could vary. The process 1000 begins with the controller 200 determining that the first voltage value of the first subcore module 125A is greater than the second voltage value of the second subcore module 125B (STEP 1005). At STEP 1010, the controller 200 determines whether the subcore module being commanded is the first subcore module 125A. If, at STEP 1010, the controller 200 determines that the second subcore module 125B is being commanded, the controller 200 commands the second subcore module 125B to operate in a normal mode of operation (STEP 1015). If, at STEP 1010, the controller 200 determines that the first subcore module 125A is being commanded, the controller 200 commands the first subcore module 125A to activate the first magnetic field source 900A (STEP 1020). In response to activation of the first magnetic field source 900A, the first reed switch 905A of the first subcore module 125A is closed, enabling current drawn from the first stack of battery cells 126A to flow through the first load 910A (STEP 1025). At STEP 1030, the controller 200 determines whether the first voltage value of the first subcore module 125A has decreased to a termination threshold. If, at STEP 1030, the controller 200 determines that the first voltage value has not decreased by the termination threshold, the controller 200 commands the first subcore module 125A to continue activating the first magnetic field source 900A (STEP 1020). If, at STEP 1030, the controller 200 determines that the first voltage value has decreased to the termination threshold, the controller 200 commands the first subcore module 125A to deactivate the first magnetic field source 900A (STEP 1035). In response to deactivation of the first magnetic field source 900A, the first reed switch 905A of the first subcore module 125A is opened, preventing current drawn from the first stack of battery cells 126A from flowing through the first load 910A (STEP 1040). The controller 200 then commands the first subcore module 125A to operate in a normal mode of operation (STEP 1015). When the first subcore module 125A and the second subcore module 125B are operating in the normal operation mode, the process 1000 is complete. With reference to FIG. 6, after the process 1000 is performed at STEP 625 of process 600, the process 600 returns to STEP 605 where an updated first voltage value of the first subcore module 125A is received by the controller 200.

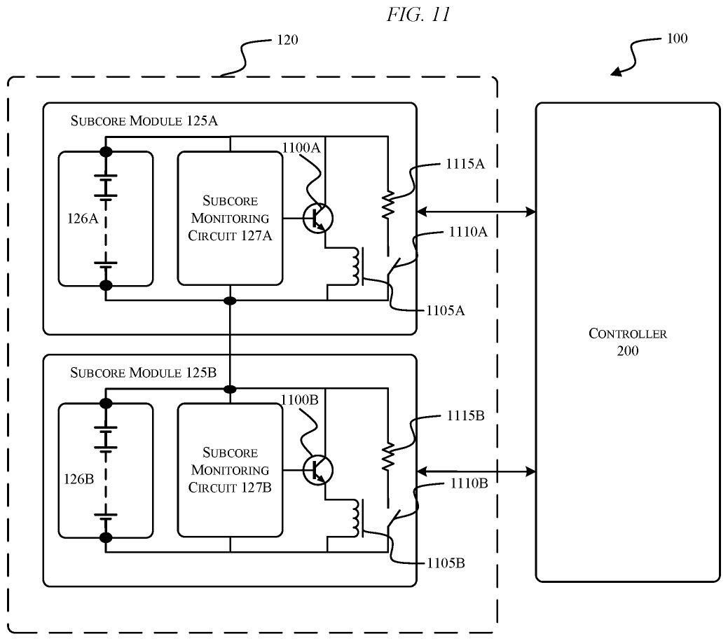

FIG. 11 illustrates an embodiment of the power source 100 in which the controller 200 and subcore modules 125A-125N are configured to perform a balancing operation when the controller 200 determines that an unbalanced condition is present at STEP 620 of process 600. As shown in FIG. 11, subcore module 125A includes, among other things, a stack of battery cells 126A, a subcore monitoring circuit 127A, a relay control circuit 1100A, a relay coil 1105A, a relay 1110A, and a relay load 1115A. Likewise, subcore module 125B includes, among other things, a stack of battery cells 126B, a subcore monitoring circuit 127B, a relay control circuit 1100B, a relay coil 1105B, a relay 1110B, and a relay load 1115B. Although illustrated as being a transistor, relay control circuits 1100A and 1100B may be implemented as another controllable switching device. In some embodiments, the relay loads 1115A and 1115B are implemented as resistors, diodes, or other ohmic components. Although FIG. 11 only shows the internal power source 120 of power supply 100 as including subcore modules 125A and 125B, it should be understood that the internal power source 120 may include as many subcore modules 125A-125N as desired. Furthermore, the balancing operation performed by controller 200 is applied to an internal power source 120 having any number of subcore modules 125A-125N.

During execution of the balancing operation, the controller 200 is configured to command any unbalanced subcore modules 125A-125N having a high voltage value to energize the respective relay coils 1105A-1105N. For example, the controller 200 commands the subcore monitoring circuits 127A-127N to control the relay control circuits 1100A-1100N of the high voltage subcore modules 125A-125N to enable current flow through the respective relay coils 1105A-1105N. In some embodiments, the controller 200 commands the relay control circuits 1100A-1100N directly. Any subcore modules 125A-125N that are not of a high voltage are not commanded by the controller 200 to energize the respective relay coils 1105A-1105N.

As an illustrative example, the subcore module 125A is of a high voltage and was commanded by controller 200 to energize the relay coil 1105A. Additionally, the subcore module 125B is not of a high voltage and was not commanded by the controller 200 to energize the relay coil 1105A. When the controller 200 commands subcore module 125A to energize relay coil 1105A, subcore monitoring circuit 127A controls the relay control circuit 1100A to enable current to flow from the stack of battery cells 126A through the relay coil 1105A. For example, if the relay control circuit 1100A is implemented as a transistor, the relay control circuit 1100A turns ON the transistor to enable current flow. When current flows through the relay coil 1105A, the normally open relay 1110A is subsequently closed, and current flows from the stack of battery cells 126A through the relay load 1115A. As a result, during execution of the balancing operation, subcore module 125A will consume more current from the stack of battery cells 126A when the relay coil 1105A is energized than subcore module 125B will consume from the stack of battery cells 126B when relay coil 1105B is not energized. Thus, the voltage, or state of charge, of subcore module 125A will be reduced at a faster rate than the voltage of subcore module 125B when the relay coil 1105A is energized and relay coil 1105B is not energized.

In some embodiments, the controller 200 commands subcore module 125A to energize the relay coil 1105A until the voltage of subcore module 125A decreases by a configurable threshold amount, for example 0.5 V. The relay coil 1105 continues drawing current from the stack of battery cells 126A, causing the relay 1110A to remain closed and the relay load 1115A to consume current until the voltage of the stack of battery cells 126A decreases by a configurable threshold amount. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to energize the relay coil 1105A until the voltage of subcore module 125A decreases by 2 volts. Alternatively, if the voltage of subcore module 125A is greater than the voltage of subcore module 125B by 0.5 volts, the controller 200 may command the subcore module 125A to energize the relay coil 1105A until the voltage of subcore module 125A decreases by 0.5 volts. When the voltage of subcore module 125A decreases by the configurable threshold amount, the controller 200 commands the subcore module 125A to de-energize the relay coil 1105A. As a result, the relay control circuit 1100A prevents current flow from the stack of battery cells 126A to the relay coil 1105A, causing the relay coil 1110A to open. Thus, current drawn from the stack of battery cells 126A is no longer able to flow through relay load 1115A.

In some embodiments, the controller 200 commands subcore module 125A to energize the relay coil 1105A until the voltage difference between subcore module 125A and subcore module 125B is below a selectable or configurable threshold amount. The configurable threshold amount may be a scalar voltage value, such as 0.1 V. In some embodiments, the configurable threshold amount is a maximum allowable percentage voltage difference, such as 0.2%. When the relay coil 1105A is energized, the controller 200 periodically determines an updated voltage difference between the first subcore module 125A and the second subcore module 125B. If the controller 200 determines the updated voltage difference between subcore module 125A and subcore module 125B is less than the configurable threshold amount, the controller 200 commands the subcore module 125A to de-energize the relay coil 1105A. Accordingly, the relay control circuit 1100A prevents current flow from the stack of battery cells 126A to the relay coil 1105A, causing the relay coil 1110A to open. Thus, current drawn from the stack of battery cells 126A is no longer able to flow through relay load 1115A.

In other embodiments, the controller 200 may command the subcore module 125A to energize the relay coil 1105A for a configurable amount of time, for example 15 seconds. The configurable amount of time may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to energize the relay coil 1105A for 2 minutes. Alternatively, if the voltage of subcore module 125A is greater than the voltage of subcore module 125B by 0.5 volts, the controller 200 may command the subcore module 125A to energize the relay coil 1105A for 30 seconds. When the controller 200 determines that the relay coil 1110A has been energized for the configurable amount of time, the controller 200 commands the subcore module 125A to de-energize the relay coil 1105A. Accordingly, the relay control circuit 1100A prevents current flow from the stack of battery cells 126A to the relay coil 1105A, causing the relay coil 1110A to open. Thus, current drawn from the stack of battery cells 126A is no longer able to flow through relay load 1115A.

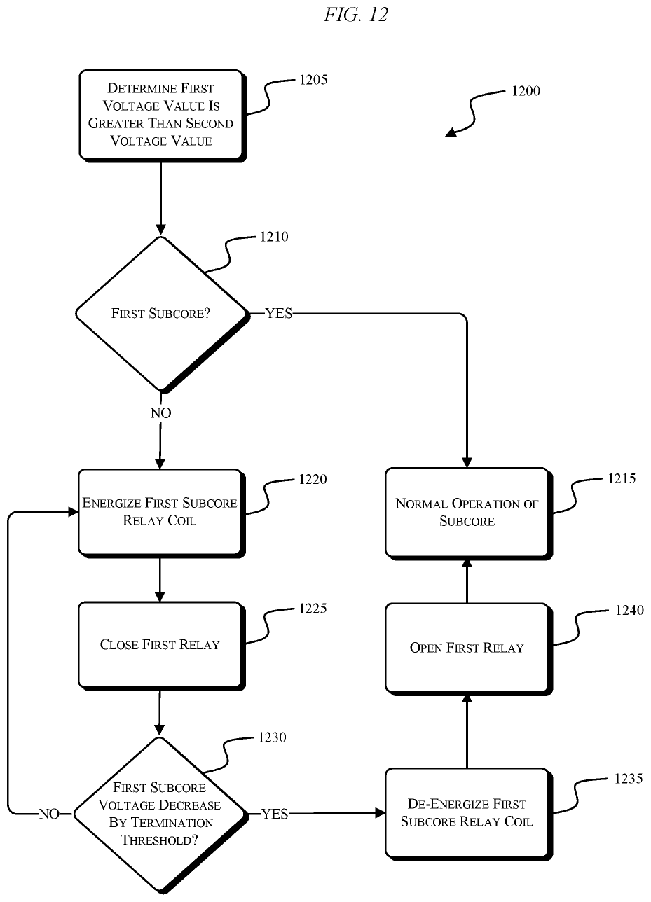

FIG. 12 is a flowchart illustrating a process 1200 for an electromechanical relay balancing operation performed by controller 200 (e.g., at STEP 625 of process 600 described above). It should be understood that the order of steps disclosed in the electromechanical relay balancing operation 1200 could vary. The process 1200 begins with the controller 200 determining that the first voltage value of the first subcore module 125A is greater than the second voltage value of the second subcore module 125B (STEP 1205). At STEP 1210, the controller 200 determines whether the subcore module being commanded is the first subcore module 125A. If, at STEP 1210, the controller 200 determines that the second subcore module 125B is being commanded, the controller 200 commands the second subcore module 125B to operate in a normal mode of operation (STEP 1215). If, at STEP 1210, the controller 200 determines that the first subcore module 125A is being commanded, the controller 200 commands the first subcore module 125A to energize the first relay coil 1105A of the first subcore module 125A (STEP 1220). In response to the first relay coil 1105A being energized, the first relay 1110A of the first subcore module 125A is closed, enabling current drawn from the first stack of battery cells 126A to flow through the relay load 1115A (STEP 1225). At step 1230, the controller 200 determines whether the first voltage value of the first subcore module 125A has decreased to a termination threshold. If, at STEP 1230, the controller 200 determines that the first voltage value has not decreased to the termination threshold, the controller 200 commands the first subcore module 125A to continue energizing the first relay coil 1105A (STEP 1220). If, at STEP 1230, the controller 200 determines that the first voltage value has decreased by the termination threshold, the controller 200 commands the first subcore module 125A to de-energize the first relay coil 1105A (STEP 1235). In response to the first relay coil being de-energized, the first relay 1110A is opened, preventing current drawn from the stack of battery cells 126A from flowing through the relay load 1115A (STEP 1240). The controller 200 then commands the first subcore module 125A to operate in a normal mode of operation (STEP 1215). When the first subcore module 125A and the second subcore module 125B are operating in the normal operation mode, the process 1200 is complete. With reference to FIG. 6, after the process 1200 is performed at STEP 625 of process 600, the process 600 returns to STEP 605 where an updated first voltage value of the first subcore module 125A is received by the controller 200.

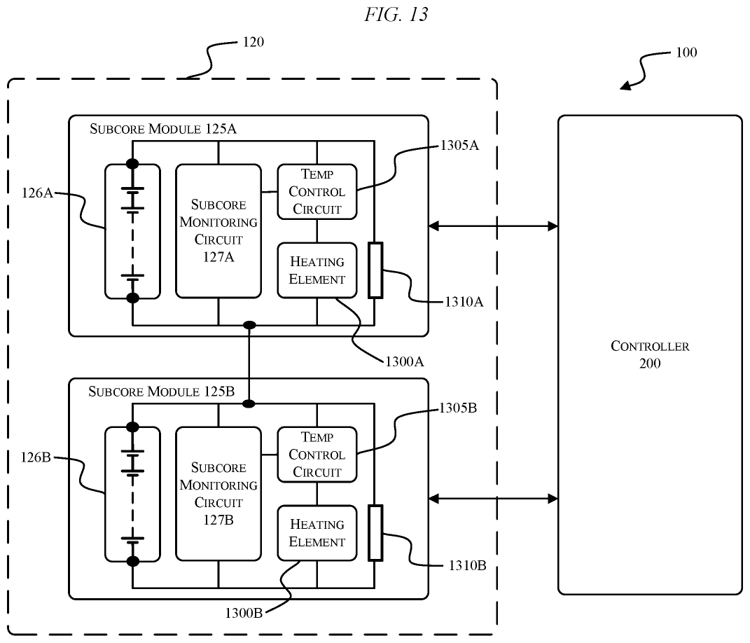

FIG. 13 illustrates an embodiment of the power supply 100 in which the controller 200 and subcore modules 125A-125N are configured to perform a balancing operation when the controller 200 determines that an unbalanced condition is present at STEP 620 of process 600. As shown in FIG. 13, subcore module 125A includes, among other things, a stack of battery cells 126A, a subcore monitoring circuit 127A, a heating element 1300A, a temperature control circuit 1305A, and a leakage device 1310A. Likewise, subcore module 125B includes, among other things, a stack of battery cells 126B, a subcore monitoring circuit 127B, a heating element 1300B, a temperature control circuit 1305B, and a leakage device 1310B. The heating elements 1300A and 1300B are devices which, when enabled, generate sufficient heat for raising the temperature of the respective leakage devices 1310A and 1310B. The heating elements 1300A and 1300B are, for example, diodes, power resistors, other ohmic components, bimetallic switches, transistors, or the like. The leakage devices 1310A and 1310B are semiconductor devices that exhibit low leakage current at room temperature and high leakage current at an elevated temperature. The leakage devices 1310A and 1310B are, for example, reverse-based diodes, transient-voltage-suppression diodes, or the like. Although FIG. 13 only shows the internal power source 120 of power supply 100 as including subcore modules 125A and 125B, it should be understood that the internal power source 120 may include as many subcore modules 125A-125N as desired. Additionally, the balancing operation performed by controller 200 is used for an internal power source 120 having any number of subcore modules 125A-125N.

During execution of the balancing operation, the controller 200 is configured to command any subcore modules 125A-125N having a high voltage value to increase the temperatures of respective heating elements 1300A-1300N. For example, the controller 200 commands the subcore monitoring circuits 127A-127N to control the temperature control circuits 1305A-1305N of the high voltage subcore modules 125A-125N to increase the temperatures of respective heating elements 1300A-1300N. In some embodiments, the controller 200 commands the temperature control circuits 1305A-1305N directly. Any subcore modules 125A-125N that are not of a high voltage are not commanded by the controller 200 to increase the temperatures of the respective heating elements 1300A-1300N.

As an illustrative example, the subcore module 125A is of a high voltage and was commanded by controller 200 to increase the temperature of heating element 1300A. Additionally, the subcore module 125B is not of a high voltage and was not commanded by the controller 200 to increase the temperature of heating element 1300B. When the controller 200 commands subcore module 125A to increase the temperature of heating element 1300A, subcore monitoring circuit 127A controls the temperature control circuit 1305A to enable current to flow from the stack of battery cells 126A through the heating element 1300A. When current flows through the heating element 1300A, the temperature of heating element 1300A is increased, and subsequently, the temperature of leakage device 1310A is also increased. When the temperature of leakage device 1310A is increased, the leakage device 1310A will experience increased leakage current. Thus, the leakage device 1310A consumes more current from the stack of battery cells 126A at an elevated temperature than when at room temperature. Accordingly, during execution of the balancing operation, heating element 1300A and leakage device 1310A will consume more current from the stack of battery cells 126A when the temperature of heating element 1300A is increased than heating element 1300B and leakage device 1310B will consume from the stack of battery cells 126B when the temperature of heating element 1300B is not increased. As a result, the voltage, or state of charge, of subcore module 125A will be reduced at a faster rate than the voltage of subcore module 125B when heating element 1300A is heated and heating element 1300B is not heated.

In some embodiments, the controller 200 commands subcore module 125A to maintain the temperature of heating element 1300A at an increased temperature until the voltage of subcore module 125A decreases by a configurable threshold amount, for example 0.5 V. For example, the temperature control circuit 1305A controls the heating element 1300A to continue drawing current from the stack of battery cells 126A, causing the heating element 1300A and leakage device 1310A to remain at elevated temperatures and consume current until the voltage of the stack of battery cells 126A decreases by a configurable threshold amount. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to heat the heating element 1300A until the voltage of subcore module 125A decreases by 2 volts. Alternatively, if the voltage of subcore module 125A is greater than the voltage of subcore module 125B by 0.5 volts, the controller 200 may command the subcore module 125A to heat the heating element 1300A until the voltage of subcore module 125A decreases by 0.5 volts. When the voltage of subcore module 125A decreases by the configurable threshold amount, the controller 200 commands the subcore module 125A to decrease the temperature of heating element 1300A. Accordingly, the temperature control circuit 1305A prevents current flow from the stack of battery cells 126A to the heating element 1300A, causing the temperatures of heating element 1300A and leakage device 1310A to decrease. Thus, the current drawn by heating element 1300A and leakage device 1310A from the stack of battery cells 126A is decreased.

In some embodiments, the controller 200 commands subcore module 125A to maintain the temperature of heating element 1300A at an increased temperature until the voltage difference between subcore module 125A and subcore module 125B is below a selectable or configurable threshold amount. The configurable threshold amount may be a scalar voltage value, such as 0.1 V. In some embodiments, the configurable threshold amount is a maximum allowable percentage voltage difference, such as 0.2%. When the heating element 1300A is at an increased temperature, the controller 200 periodically determines an updated voltage difference between the first subcore module 125A and the second subcore module 125B. If the controller 200 determines the updated voltage difference between subcore module 125A and subcore module 125B is less than the configurable threshold amount, the controller 200 commands the subcore module 125A to decrease the temperature of heating element 1300A. Accordingly, the temperature control circuit 1305A prevents current flow from the stack of battery cells 126A to the heating element 1300A, causing the temperatures of heating element 1300A and leakage device 1310A to decrease. Thus, the current drawn by heating element 1300A and leakage device 1310A from the stack of battery cells 126A is decreased.

In other embodiments, the controller 200 commands subcore module 125A to maintain the temperature of heating element 1300A at an increased temperature for a configurable amount of time, for example 15 seconds. The configurable amount of time may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to maintain the temperature of heating element 1300A at an increased temperature for 2 minutes. Alternatively, if the voltage of subcore module 125A is greater than the voltage of subcore module 125B by 0.5 volts, the controller 200 may command the subcore module 125A to maintain the temperature of heating element 1300A at an increased temperature for 30 seconds. When the controller 200 determines that the heating element 1300A has been maintained at an increased temperature for the configurable amount of time, the controller 200 commands the subcore module 125A to decrease the temperature of heating element 1300A. Accordingly, the temperature control circuit 1305A prevents current flow from the stack of battery cells 126A to the heating element 1300A, causing the temperatures of heating element 1300A and leakage device 1310A to decrease. Thus, the current drawn by heating element 1300A and leakage device 1310A from the stack of battery cells 126A is decreased.

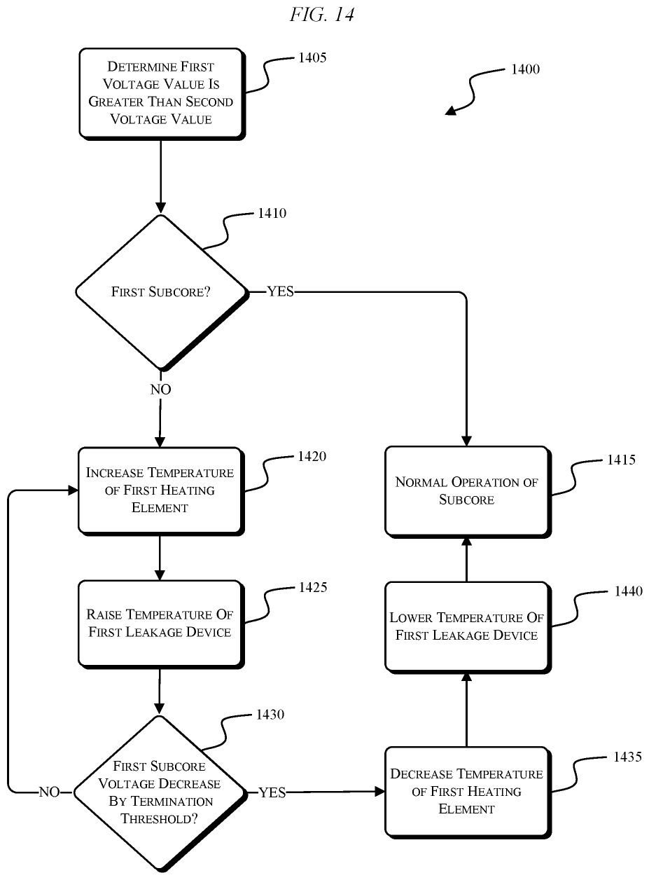

FIG. 14 is a flowchart illustrating a process 1400 for a temperature controlled balancing operation performed by controller 200 (e.g., at STEP 625 of process 600 described above). It should be understood that the order of steps disclosed in the temperature controlled balancing operation 1400 could vary. The process 1400 begins with the controller 200 determining that the first voltage value of the first subcore module 125A is greater than the second voltage value of the second subcore module 125B (STEP 1405). At STEP 1410, the controller 200 determines whether the subcore module being commanded is the first subcore module 125A. If, at STEP 1410, the controller 200 determines that the second subcore module 125B is being commanded, the controller 200 commands the second subcore module 125B to operate in a normal mode of operation (STEP 1415). If, at STEP 1410, the controller 200 determines that the first subcore module 125A is being commanded, the controller 200 commands the first subcore module 125A to increase the temperature of the first heating element 1300A included in the first subcore module 125A (STEP 1420). In response to the temperature of the first heating element 1300A being increased, the temperature of the first leakage device 1310A is increased, which causes the amount current drawn by the first leakage device 1310A from the stack of battery cells 126A to increase (STEP 1425). At step 1430, the controller 200 determines whether the first voltage value of the first subcore module 125A has decreased to a termination threshold. If, at STEP 1430, the controller 200 determines that the first voltage value has not decreased by the termination threshold, the controller 200 commands the first subcore module 125A to maintain the first heating element 1300A at an increased temperature (STEP 1420). If, at STEP 1430, the controller 200 determines that the first voltage value has decreased by the termination threshold, the controller 200 commands the first subcore module 125A to decrease the temperature of the first heating element 1300A (STEP 1435). In response to the temperature of the first heating element 1300A being decreased, the temperature of the first leakage device 1310A is decreased, reducing the amount of current drawn by the first leakage device 1310A from the stack of battery cells 126A (STEP 1040). The controller 200 then commands the first subcore module 125A to operate in a normal mode of operation (STEP 1415). When the first subcore module 125A and the second subcore module 125B are operating in the normal operation mode, the temperature controlled balancing operation 1400 is complete. With reference to FIG. 6, after the temperature controlled balancing operation 1400 is performed at STEP 625 of process 600, the process 600 returns to STEP 605 where an updated first voltage value of the first subcore module 125A is received by the controller 200.

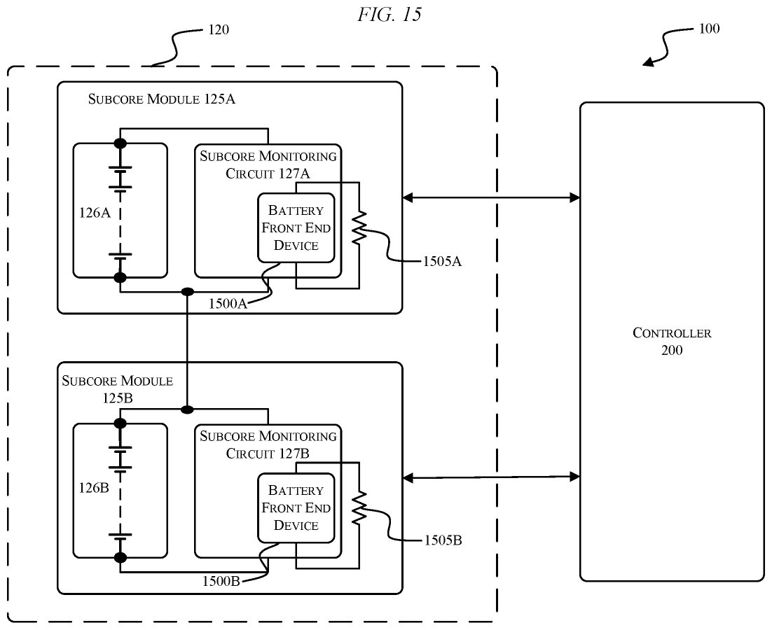

FIG. 15 illustrates an embodiment of the power source 100 in which the controller 200 and subcore modules 125A-125N are configured to perform a balancing operation when the controller 200 determines that an unbalanced condition is present at STEP 620 of process 600. As shown in FIG. 15, subcore module 125A includes, among other things, a stack of battery cells 126A, a subcore monitoring circuit 127A, a battery front end device 1500A, and a front end load 1505A. Likewise, subcore module 125B includes, among other things, a stack of battery cells 126B, a battery front end device 1500B, and a front end load 1505B. The battery front end devices 1500A and 1500B are devices, such as microchips, included in the respective subcore monitoring circuits 127A and 127B. The front end loads 1505A and 1505B are selectively activated and connected to output pins of the respective battery front end devices 1500A and 1500B. The front end loads 1505A and 1505B may be, for example, resistors, diodes, ohmic components, or the like. Although FIG. 15 only shows the internal power source 120 of power supply 100 as including subcore modules 125A and 125B, it should be understood that the internal power source 120 may include as many subcore modules 125A-125N as desired. Additionally, the balancing operation performed by controller 200 may be used for an internal power source 120 having any number of subcore modules 125A-125N.

During execution of the balancing operation, the controller 200 is configured to command any unbalanced subcore modules 125A-125N having a high voltage value to enable the front end loads 1505A-1505N connected to output pins of the respective battery front end devices 1500A-1500N. As an illustrative example, the subcore module 125A is of a high voltage and was commanded by controller 200 to enable the front end load 1505A connected to an output pin of the battery front end device 1500A. Additionally, the subcore module 125B is not of a high voltage and was not commanded by the controller 200 to enable the front end load 1505B connected to an output pin of the front end device 1500B. When the controller 200 commands subcore module 125A to enable the front end load 1505A, the subcore monitoring circuit 127A controls the battery front end device 1500A to enable current drawn from the stack of battery cells 126A to flow through the front end load 1505A. Accordingly, when the front end load 1505A is enabled to draw current from the stack of battery cells 126A, the voltage, or state of charge, of subcore module 125A will be reduced at a faster rate than the voltage of subcore module 125B when front end load 1505B is not enabled. In some embodiments, the controller 200 commands the battery front end device 1500A directly.

In some embodiments, the controller 200 commands subcore module 125A to enable the front end load 1505A until the voltage of subcore module 125A decreases by a configurable threshold amount, for example 0.5 V. For example, the controller 200 controls battery front end device 1500A to enable current drawn from the stack of battery cells 126A to flow through front end load 1505A until the voltage of the stack of battery cells 126A decreases by a configurable threshold amount. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to enable the front end load 1505A until the voltage of subcore module 125A decreases by 2 volts. Alternatively, if the voltage of subcore module 125A is greater than the voltage of subcore module 125B by 0.5 volts, the controller 200 may command the subcore module 125A to enable the front end load 1505A until the voltage of subcore module 125A decreases by 0.5 volts. When the voltage of subcore module 125A decreases by the configurable threshold amount, the controller 200 commands the subcore module 125A to disable the front end load 1505A. Accordingly, the battery front end device 1500A prevents current flow from the stack of battery cells 126A to the front end load 1505A, reducing the current drawn from the stack of battery cells 126A.

In some embodiments, the controller 200 commands subcore module 125A to enable the front end load 1505A until the voltage difference between subcore module 125A and subcore module 125B is below a selectable or configurable threshold amount. The configurable threshold amount may be a scalar voltage value, such as 0.1 V. In some embodiments, the configurable threshold amount is a maximum allowable percentage voltage difference, such as 0.2%. When the front end load 1505A is enabled and consumes current, the controller 200 periodically determines an updated voltage difference between the first subcore module 125A and the second subcore module 125B. If the controller 200 determines the updated voltage difference between subcore module 125A and subcore module 125B is less than the configurable threshold amount, the controller 200 commands the subcore module 125A to disable the front end load 1505A. Accordingly, the battery front end device 1500A prevents current flow from the stack of battery cells 126A to the front end load 1505A, reducing the current drawn from the stack of battery cells 126A.

In other embodiments, the controller 200 commands subcore module 125A to enable the front end load 1505A for a configurable amount of time, for example 15 seconds. The configurable amount of time may be determined in accordance with the determined difference between the voltage values of subcore modules 125A and 125B. For example, if the voltage of subcore module 125A is greater than the voltage of subcore module 125B by 2 volts, the controller 200 may command the subcore module 125A to enable the front end load 1505A for 2 minutes. Alternatively, if the voltage of subcore module 125A is greater than the voltage of subcore module 125B by 0.5 volts, the controller 200 may command the subcore module 125A to enable the front end load 1505A for 30 seconds. When the controller 200 determines that the front end load 1505A of the battery front end device 1500A has been enabled for the configurable amount of time, the controller 200 commands the subcore module 125A to disable the front end load 1505A. Accordingly, the battery front end device 1500A prevents current flow from the stack of battery cells 126A to the front end load 1505A, reducing the current drawn from the stack of battery cells 126A.

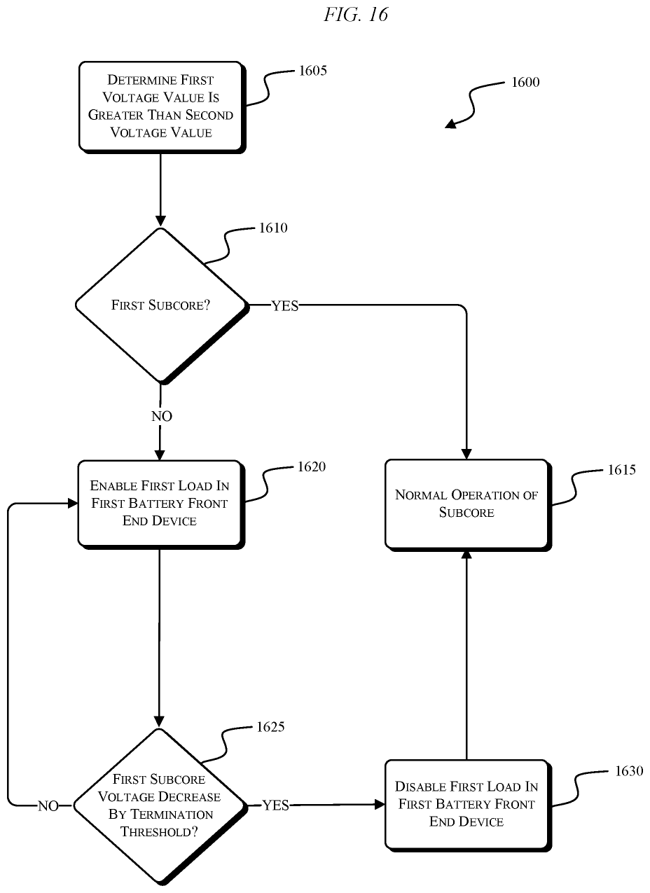

FIG. 16 is a flowchart illustrating a process 1600 for a battery front end balancing operation performed by controller 200 (e.g., at STEP 625 of process 600 described above). It should be understood that the order of steps disclosed in the battery front end balancing operation 1600 could vary. The battery front end balancing operation 1600 begins with the controller 200 determining that the first voltage value of the first subcore module 125A is greater than the second voltage value of the second subcore module 125B (STEP 1605). At STEP 1610, the controller 200 determines whether the subcore module being commanded is the first subcore module 125A. If, at STEP 1610, the controller 200 determines that the second subcore module 125B is being commanded, the controller 200 commands the second subcore module 125B to operate in a normal mode of operation (STEP 1615). If, at STEP 1610, the controller 200 determines that the first subcore module 125A is being commanded, the controller 200 commands the first subcore module 125A to enable the first front end load 1505A, causing the first front end load 1505A to consume current drawn from the first stack of battery cells 126A (STEP 1620). At step 1625, the controller 200 determines whether the first voltage value of the first subcore module 125A has decreased by a termination threshold. If, at STEP 1625, the controller 200 determines that the first voltage value has not decreased by the termination threshold, the controller 200 commands the first subcore module 125A to continue enabling the front end load 1505A (STEP 1620). If, at STEP 1625, the controller 200 determines that the first voltage value has decreased by the termination threshold, the controller 200 commands the first subcore module 125A to disable the first front end load 1505A (STEP 1630). When the first front end load 1505A is disabled, the first subcore module 125A operates in a normal mode of operation (STEP 1615). When the first subcore module 125A and the second subcore module 125B are operating in the normal operation mode, the process 1600 is complete. After the process 1600 is performed at STEP 625 of process 600, the process 600 returns to STEP 605 where an updated first voltage value of the first subcore module 125A is received by the controller 200.

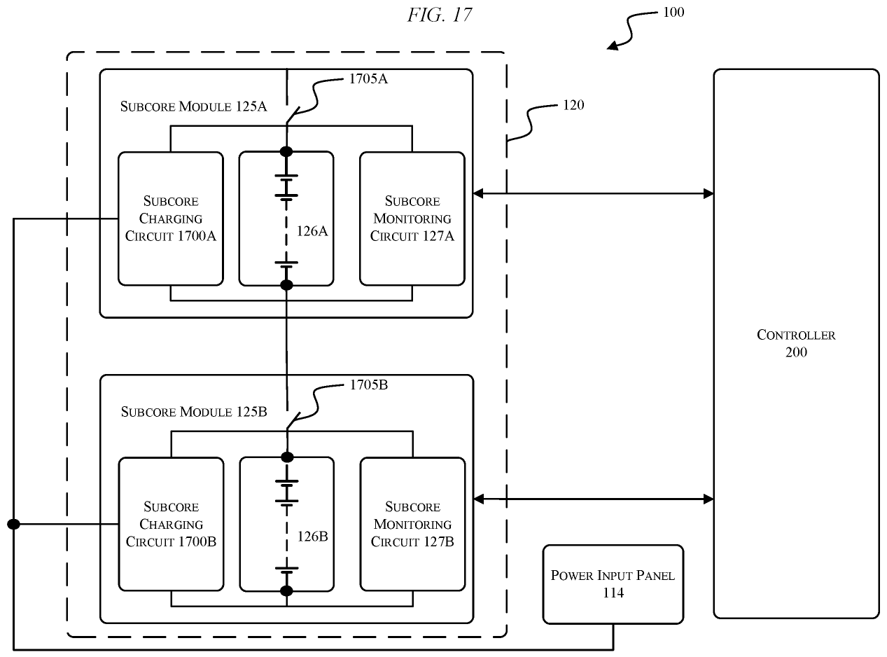

FIG. 17 illustrates an embodiment of the power supply 100 in which the controller 200 and subcore modules 125A-125N are configured to perform balanced charging. As described above with respect to FIG. 2, subcore modules 125A-125N are configured to receive charging power from power input panel 114. As shown in FIG. 17, charging power is delivered from power input panel 114 to subcore charging circuits 1700A-1700N included in subcore modules 125A-125N. Subcore charging circuit 1700A-1700N are electrically connected to the respective stacks of battery cells 126A-126N. In some embodiments, the subcore charging circuits are communicatively and/or electrically connected to controller 200.

During balanced charging of the power supply 100, the controller 200 is configured to monitor voltage signals received from the subcore modules 125A-125N to determine whether the voltage value of any subcore module 125A-125N has reached a charge termination threshold, indicating the subcore module 125A-125N is fully charged. In some embodiments, the charge termination threshold is a scalar voltage value, such as 21V. In other embodiments, the balance threshold may be a selectable or configurable percentage value, such as 99% of a voltage capacity of subcore modules 125A-125N. If the controller 200 determines that the voltage of a subcore module 125 has reached the charge termination threshold, the controller 200 controls the subcore charging circuit 1700 of the fully charged subcore module to stop charging the charged subcore module 125. However, subcore modules 125A-125N that are not fully charged will continue to be charged. In some embodiments, the controller 200 can selectively charge an individual subcore module 125 based on whether the voltage value of the individual subcore module 125 has reached the charge termination threshold.

With respect to FIG. 17, if the maximum voltage capacity of subcore modules 125A and 125B is equal to 21V, the controller 200 will selectively charge subcore module 125A until the voltage of subcore module 125A reaches the charge termination threshold (i.e., 21V) independent of the voltage of subcore module 125B. Likewise, the controller 200 will selectively charge subcore module 125B until the voltage of subcore module 125B reaches the charge termination threshold (i.e., 21V) independent of the voltage of subcore module 125A. For example, if the controller 200 determines the voltage of subcore module 125A to be equal to 21V, the controller 200 will control subcore charging circuit 1700A to stop charging the stack of battery cells 126A. If the controller 200 determines the voltage of subcore module 125B to be equal to 20.5V, the controller 200 will control subcore charging circuit 1700B to continue charging the stack of battery cells 126B even though subcore module 125A is no longer being charged. In some embodiments, a fully charged subcore module 125 is configured to electrically disconnect from the series and/or parallel connected subcore modules 125A-125N included in internal power source 120. For example, when the voltage of subcore module 125A reaches the charge termination threshold, the controller 200 is configured to open disconnect switch 1705A included in subcore module 125A. When disconnect switch 1705A is opened, subcore module 125A is electrically disconnected from the undercharged subcore modules 125B-125N. In some embodiments, the disconnect switch 1705A includes multiple switches that are selectively controlled by controller 200.

In addition to determining whether subcore module 125A-125N voltages have reached a charge termination threshold, the controller 200 is further configured to monitor voltage signals received from the subcore modules 125A-125N to determine whether a subcore unbalanced condition is present in the internal power source 120. As described above with respect to FIGS. 2-5, the controller 200 may be configured to execute the subcore evaluation program during balanced charging of the power supply 100. While executing the subcore evaluation program, the controller 200 is configured to calculate differences between the voltage values of subcore modules 125A-125N. For example, if the internal power source 120 of power supply 100 includes two subcore modules, subcore module 125A and subcore module 125B, the controller 200 calculates a difference between the voltage values of subcore module 125A and subcore module 125B. If the voltage value of subcore module 125A is equal to 21V and the voltage value of subcore module 125B is equal to 20V, the calculated voltage difference between subcore module 125A and subcore module 125B is equal to 1V. As a result, the voltage values of subcore module 125A and subcore module 125B would differ by 4.8%. Although the described example refers to the internal power source 120 as having two subcore modules 125A and 125B, it should be understood that the controller 200 is configured to execute the subcore evaluation program for an internal power supply 120 having any number of subcore modules 125A-125N. As a result, the controller 200 is configured to calculate a difference between the voltage values of each respective subcore module 125A-125N.

The calculated voltage differences are compared to a balance threshold. The balance threshold is a selectable or configurable value that may be stored memory 425 of controller 200. In some embodiments, the balance threshold is a scalar voltage value, such as 0.5 volts. In other embodiments, the balance threshold may be a configurable percentage value. For example, the balance threshold may be a percentage difference between voltage values, such as 1%. If the controller 200 determines at least one voltage difference between any of the subcore modules 125A-125N to be greater than or equal to the balance threshold, the controller 200 performs a charge balancing operation.

With reference to the example provided above, the controller 200 determines the voltage difference between subcore module 125A and subcore module 125B to be 1V. If it is assumed that the balance threshold is equal to 0.5V, the controller 200 determines that the voltage difference (1V) between subcore module 125A and subcore module 125B exceeds the balance threshold. Accordingly, the controller 200 performs a charging balancing operation to reduce the difference, or unbalance, between the voltage values of subcore module 125A and subcore module 125B during balanced charging of the power supply 100. In some embodiments, the controller 200 is configured to perform the charging balancing operation for a configurable amount of time, such as 15 seconds. In some embodiments, the controller 200 performs the charging balancing operation until the unbalanced condition between subcore modules 125A and 125B is no longer present. In such embodiments, the controller 200 performs the balancing operation until the difference in voltage values of subcore module 125A and subcore module 125B is below the balance threshold. In some embodiments, the controller 200 performs the balancing operation until the difference in voltage values of subcore module 125A and subcore module 125B is below a balancing operation termination threshold. The balancing operation termination threshold is a selectable or configurable threshold that is less than the balance threshold. For example, assuming the balance threshold is 0.5V, the balancing operation termination threshold may be set to 0.1V.

Although the example provided above refers to the internal power source 120 as having two subcore modules 125A and 125B, it should be understood that the controller 200 executes the subcore evaluation program for an internal power supply 120 having any number of subcore modules 125A-125N. As a result, the controller 200 is configured to calculate a difference between the voltage values of each respective subcore module 125A-125N. If the controller 200 determines that one or more voltage differences between subcore modules 125A-125N are greater than or equal to the balance threshold, the controller 200 is configured to perform the charging balancing operation.

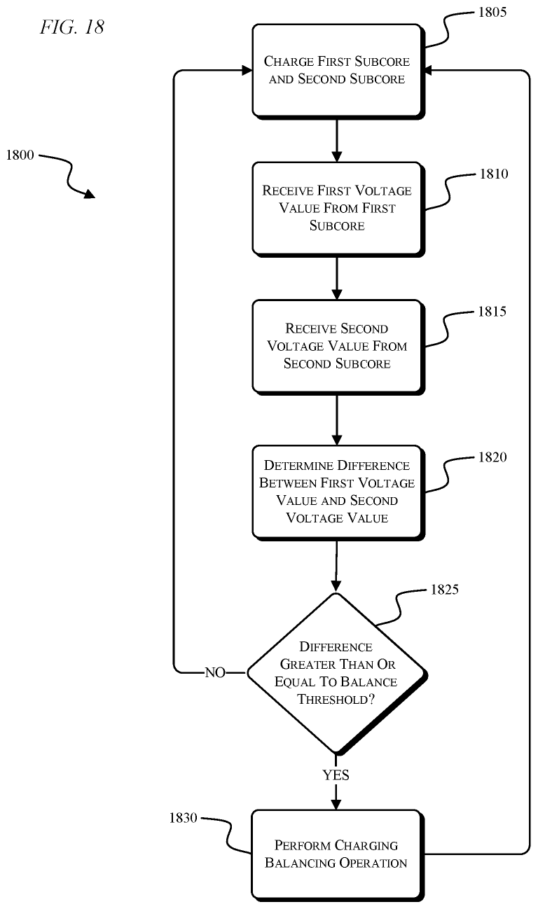

FIG. 18 is a flowchart illustrating a balanced charging process 1800 for charging subcore modulus 125A-125N include in the internal power source 120 of the power supply 100. It should be understood that the order of steps disclosed in process 1800 could vary. The process 1800 begins with charging a first subcore module 125A and a second subcore module 125B (STEP 1805). As described above, the first subcore charging circuit 1700A charges the first stack of battery cells 126A with power received from the power input panel 114. Likewise, the second subcore charging circuit 1700B charges the second stack of battery cells 126B with power received from the power input panel 114. While the first subcore module 125A and the second subcore module 125B are being charged, the controller 200 receives a first voltage value from the first subcore module 125A (STEP 1810). The controller 200 receives a second voltage value from the second subcore module 125B (STEP 1815). The controller 200 determines a difference between the first voltage value and the second voltage value (STEP 1820). In some embodiments, the difference between the first voltage value and the second voltage value is determined as a scalar value or as a percentage difference. If, at STEP 1825, the controller 200 determines the difference between the first voltage value and the second voltage value to be less than a balance threshold, the process 1800 returns to STEP 1805. If, at STEP 1825, the difference between the first voltage value and the second voltage value to be greater than or equal to the balance threshold, the controller 200 performs a charging balancing operation (STEP 1830). After the charging balancing operation is performed at STEP 1830, the process 1800 returns to STEP 1805 where the first subcore module 125A and the second subcore module 125B continue charging.

During execution of the charging balancing operation at STEP 1830, the controller 200 is configured to command the subcore charging circuits 1700A-1700N of any subcore modules 125A-125N having an unbalanced low voltage to continue charging and any subcore modules 125A-125N having a high voltage value to stop or temporarily pause charging. One or more subcore modules 125A-125N may be determined to have a high voltage if the one or more subcore modules 125A-125N have voltages that are greater than one or more subcore module 125A-125N voltages by an amount that is greater than or equal to the balance threshold. Similarly, one or more subcore modules 125A-125N may be determined to have a low voltage if the one or more subcore modules 125A-125N have voltages that are less than one or more subcore module 125A-125N voltages by an amount that is greater than or equal to the balance threshold. For example, if the internal power source 120 includes subcore modules 125A and 125B, subcore module 125A are determined to have a high voltage if the voltage value of subcore module 125A is greater than the voltage value of subcore module 125B by an amount that is greater than or equal to the balance threshold. Likewise, if the internal power source 120 includes subcore modules 125A-125N, subcore modules 125B-125N are determined to have high voltages if the voltage values of subcore modules 125B-125N are greater than the voltage value of subcore module 125A by an amount that is greater than or equal to the balance threshold. It should be understood that the above examples are not limiting, as the controller 200 may determine any number of subcore modules 125A-125N to be of a high voltage or a low voltage.

As an illustrative example, the voltage of subcore module 125A is of a high voltage, such that the voltage of subcore module 125A is greater than the voltage of subcore module 125B by at least the balance threshold and subcore module 125B is of a low voltage. In some embodiments, the controller 200 simultaneously pauses the charging of subcore module 125A and commands subcore module 125B to continue charging for a configurable amount of time. For example, the controller 200 controls the subcore charging circuit 1700A to temporarily disable charging of the first stack of battery cells 126A while the subcore charging circuit 1700B continues charging the second stack of battery cells 126B for the configurable amount of time. The configurable amount of time may be determined in accordance with the determined difference between the voltage values of subcore modules 125A and 125B. For example, if the voltage of subcore module 125A is greater than the voltage of subcore module 125B by 2 volts, the controller 200 may pause the charging of subcore module 125A for 2 minutes. Alternatively, if the voltage of subcore module 125A is greater than the voltage of subcore module 125B by 0.5 volts, the controller 200 may pause the charging of subcore module 125A for 30 seconds. When the controller 200 determines that the charging of subcore module 125A has been paused for the configurable amount of time, the controller 200 commands the subcore module 125A to operate in a normal mode of operation or to be further charged.

In other embodiments, the controller 200 simultaneously pauses the charging of subcore module 125A and commands subcore module 125B to continue charging until the voltage of subcore module 125B increases by a selectable or configurable threshold amount, for example 0.5 V. The configurable threshold amount may be determined in accordance with the determined difference between the voltage values of subcore modules 125A and 125B. For example, if the voltage of subcore module 125A is greater than the voltage of subcore module 125B by 2 volts, the controller 200 may pause the charging of subcore module 125A until the voltage of subcore module 125B increases by 2 volts. Alternatively, if the voltage of subcore module 125A is greater than the voltage of subcore module 125B by 0.5 volts, the controller 200 may pause the charging of subcore module 125A until the voltage of subcore module 125B increases by 2 volts. When the voltage of subcore module 125B increases by the configurable threshold amount, the controller 200 commands the subcore module 125A to resume charging.

In some embodiments, the controller 200 simultaneously pauses the charging of subcore module 125A and commands subcore module 125B to continue charging until the voltage difference between subcore module 125A and subcore module 125B is below a selectable or configurable threshold amount. The configurable threshold amount may be scalar voltage value, such as 0.1 V. In some embodiments, the configurable threshold amount is a maximum allowable percentage voltage difference, such as 0.2%. When the charging of subcore module 125A is temporarily paused, the controller 200 periodically determines an updated voltage difference between the first subcore module 125A and the second subcore module 125B. When the controller 200 determines the updated voltage difference between subcore module 125A and subcore module 125B is less than the configurable threshold amount, the controller 200 commands the subcore module 125A to resume charging.

Thus, embodiments described herein provide, among other things, a portable power supply that includes battery module-level balancing. Various features and advantages are set forth in the following claims.

What is claimed is:

1. A portable power supply comprising:
a first subcore including a first plurality of battery cells;
a second subcore including a second plurality battery cells and electrically connected in series with the first subcore; and
a controller including an electronic processor configured to:
receive a first voltage value indicative of a voltage of the first plurality of battery cells from the first subcore,
receive a second voltage value indicative of a voltage of the second plurality of battery cells from the second subcore,
determine a difference between the first voltage value and the second voltage value;
compare the difference to a balance threshold; and
perform a balancing operation when the difference is greater than or equal to the balance threshold.

2. The portable power supply of claim 1, wherein the controller is further configured to determine whether the first voltage value is greater than the second voltage value.

3. The portable power supply of claim 2, wherein the controller is further configured to:
operate the first subcore in an active mode of operation when the first voltage value is greater than the second voltage value;
determine whether the first voltage value has decreased to a termination threshold; and
operate the first subcore in a normal mode of operation when the first voltage value has reached the termination threshold.

4. The portable power supply of claim 2, wherein the controller is further configured to:
activate a first magnetic field source included in the first subcore when the first voltage value is greater than the second voltage value to enable current flow from the first plurality of battery cells to a load through a first reed switch that is closed when the first magnetic field source is activated;
determine whether the first voltage value has decreased to a termination threshold; and
deactivate the first magnetic field source when the first voltage value has reached the termination threshold.

5. The portable power supply of claim 2, wherein the controller is further configured to:
energize a first relay coil included in the first subcore when the first voltage value is greater than the second voltage value to enable current flow from the first plurality of battery cells to a load through a first relay that is closed when the first relay coil is energized;
determine whether the first voltage value has decreased to a termination threshold; and
de-energize the first relay coil when the first voltage value has reached the termination threshold.

6. The portable power supply of claim 2, wherein the controller is further configured to:
increase a temperature of a heating element included in the first subcore when the first voltage value is greater than the second voltage value to increase current flow from the first plurality of battery cells through a leakage device included in the first subcore;
determine whether the first voltage value has decreased to a termination threshold; and
decrease the temperature of the heating element when the first voltage value has reached the termination threshold.

7. The portable power supply of claim 2, wherein the controller is further configured to:
control a battery front end device included in the first subcore when the first voltage value is greater than the second voltage value to enable current flow from the first plurality of battery cells to a load;
determine whether the first voltage value has decreased to a termination threshold; and
control the battery front end device included in the first subcore to disable current flow from the first plurality of battery cells when the first voltage value has reached the termination threshold.

8. The portable power supply of claim 7, wherein the load is electrically connected to an output pin of the battery front end device.

9. A method of balancing subcore voltages in a portable power supply, the portable power supply includes a first subcore including a first plurality of battery cells, a second subcore including a second plurality of battery cells and electrically connected in series with the first subcore, and a controller including an electronic processor, the method comprising:
receiving, using the controller, a first voltage value indicative of a voltage of the first plurality of battery cells from the first subcore;
receiving, using the controller, a second voltage value indicative of a voltage of the second plurality of battery cells from the second subcore;
determining, using the controller, a difference between the first voltage value and the second voltage value;
comparing, using the controller, the difference to a balance threshold; and
performing a balancing operation when the difference is greater than or equal to the balance threshold.

10. The method of claim 9, further comprising:
determining, using the controller, whether the first voltage value is greater than the second voltage value.

11. The method of claim 10, further comprising:
operating, using the controller, the first subcore in an active operation mode;
determining, using the controller, whether the first voltage value has decreased to a termination threshold; and
operating the first subcore in a normal operating mode when the first voltage value has reached the termination threshold.

12. The method of claim 10, further comprising:
activating, using the controller, a first magnetic field source included in the first subcore;
closing, using the first magnetic field source, a first reed switch included in the first subcore to enable current to flow from the plurality of battery cells to a first load included in the first subcore;
determining, using the controller, whether the first voltage value has decreased to a termination threshold; and
deactivating, using the controller, the first magnetic field source when the first voltage value has reached the termination threshold.

13. The method of claim 10, further comprising:
energizing, using the controller, a first relay coil included in the first subcore;
closing, using the first relay coil, a first relay included in the first subcore to enable current to flow from the plurality of battery cells to a first load included in the first subcore;
determining, using the controller, whether the first voltage value has decreased to a termination threshold; and
de-energizing, using the controller, the first relay coil when the first voltage value has reached the termination threshold.

14. The method of claim 10, further comprising:
increasing, using the controller, temperature of a heating element included in the first subcore;
increasing, using the heating element, temperature of a leakage device included in the first subcore to enable current flow from the first plurality of battery cells through the leakage device;
determining, using the controller, whether the first voltage value has decreased to a termination threshold; and
decreasing, using the controller, temperature of the heating element when the first voltage value has reached the termination threshold.

15. The method of claim 10, further comprising:
enabling, using a battery front end device included in the first subcore, current flow from the first plurality of battery cells to a load;
determining, using the controller, whether the first voltage value has decreased to a termination threshold; and
disabling, using the battery front end device, current flow from the first plurality of battery cells when the first voltage value has reached the termination threshold.

16. The method of claim 15, wherein the load is electrically connected to an output pin of the battery front end device.

17. A method of charging one or more subcores in a portable power supply, the portable power supply includes a first subcore including a first plurality of battery cells, a second subcore including a second plurality of battery cells and electrically connected in series with the first subcore, and a controller including an electronic processor, the method comprising:
charging the first plurality of battery cells and the second plurality of battery cells;
receiving, using the controller, a first voltage value indicative of a voltage of the first plurality of battery cells from the first subcore;
receiving, using the controller, a second voltage value indicative of a voltage of the second plurality of battery cells from the second subcore;
determining, using the controller, a difference between the first voltage value and the second voltage value;
comparing the difference to a balance threshold; and
performing a balancing operation when the difference is greater than or equal to the balance threshold.

18. The method of claim 17, further comprising:
comparing, using the controller, the first voltage value to a charge threshold;
determining, using the controller, whether the first voltage value is greater than or equal to the charge threshold; and
terminating charging of the first plurality of battery cells when the first voltage value is greater than or equal to the charge threshold.

19. The method of claim 18, further comprising:
comparing, using the controller, the second voltage value to a charge threshold;
determining, using the controller, whether the second voltage value is greater than or equal to the charge threshold; and
terminating charging of the second plurality of battery cells when the first voltage value is greater than or equal to the charge threshold.

20. The method of claim 17, wherein performing the balancing operation comprises:
determining, using the controller, whether the first voltage value is greater than the second voltage value;
charging the second plurality of battery cells for an amount of time when the first voltage value is greater than the second voltage value;
delaying charging of the first plurality of battery cells for the amount of time when the first voltage value is greater than the second voltage value; and
charging the first plurality of battery cells and the second plurality of battery cells after the amount of time has elapsed.
